(19) United States
(12) Patent Application Publication
(10) Pub. No.: US 2019/0258666 A1
(43) Pub. Date: Aug. 22, 2019

(54) RESOURCE ACCESSIBILITY SERVICES

(71) Applicant: HAMSTOO, INC., Greenwich, CT (US)

(72) Inventor: Frederick Crimins, Greenwich, CT (US)

(21) Appl. No.: 16/279,823

(22) Filed: Feb. 19, 2019

Related U.S. Application Data
(60) Provisional application No. 62/631,603, filed on Feb. 16, 2018.

(51) Int. Cl. G06F 16/58; H04L 29/08; G06F 16/955

(52) U.S. Cl. CPC G06F 16/5866; G06F 16/9562; H04L 67/02

(57) ABSTRACT

Systems, methods, and computer-readable media for a resource accessibility service are provided.

### CROSS-REFERENCE TO RELATED APPLICATION(S)

This application claims the benefit of prior filed U.S. Provisional Patent Application No. 62/631,603, filed Feb. 16, 2018, which is hereby incorporated by reference herein in its entirety.

### TECHNICAL FIELD

This disclosure relates to resource accessibility services and, more particularly, to services for retaining and retrieving accessed resources.

### BACKGROUND OF THE DISCLOSURE

Conventional web browser bookmarking capabilities have several disadvantages including, but not limited to, inefficient ability for a user to effectively recall the content associated with a bookmark.

### SUMMARY OF THE DISCLOSURE

This document describes systems, methods, and computer-readable media for a resource accessibility service.

As an example, a method may be provided for operating a computer that includes accessing, by the computer, a resource, defining a mark for the accessed resource, wherein the defined mark includes mark data that includes resource content retrieval data that is operative to provide at least a portion of the content of the accessed resource and system metadata associated with the accessing, storing the defined mark, and recalling the stored mark.

As another example, a method may be provided for operating a computer that includes accessing, by the computer, a resource, defining a mark for the accessed resource, wherein the defined mark includes resource content retrieval data that is operative to provide at least a portion of the content of the accessed resource and system metadata associated with the accessing, generating a question based on the defined mark, and presenting the question to a user of the computer.

As yet another example, a method may be provided for operating a computer that includes accessing, by the computer, a resource, in response to the accessing, automatically detecting that the accessed resource includes audio content with a tone range less than a threshold, in response to the detecting, automatically extending the tone range of the audio content, and automatically playing back, by the computer, the audio content with the extended tone range.

This Summary is provided only to summarize some example embodiments, so as to provide a basic understanding of some aspects of the subject matter described in this document. Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters may refer to like parts throughout, and in which:

FIG. 1 is a schematic view of an illustrative system that may provide a resource accessibility service platform (“RASP”) for facilitating various resource accessibility services of the disclosure;

FIG. 2 is a more detailed schematic view of a subsystem of the system of FIG. 1;

FIGS. 3-27 show illustrative screen shots of graphical user interfaces that may be presented to users of the system; and

FIG. 28 is a flowchart of an illustrative process for providing features of the resource accessibility service platform of the disclosure.

### DETAILED DESCRIPTION OF THE DISCLOSURE

A resource accessibility service is provided that may be operative to enable users to access resources and to retain and retrieve previously accessed resources in an effective and efficient manner.

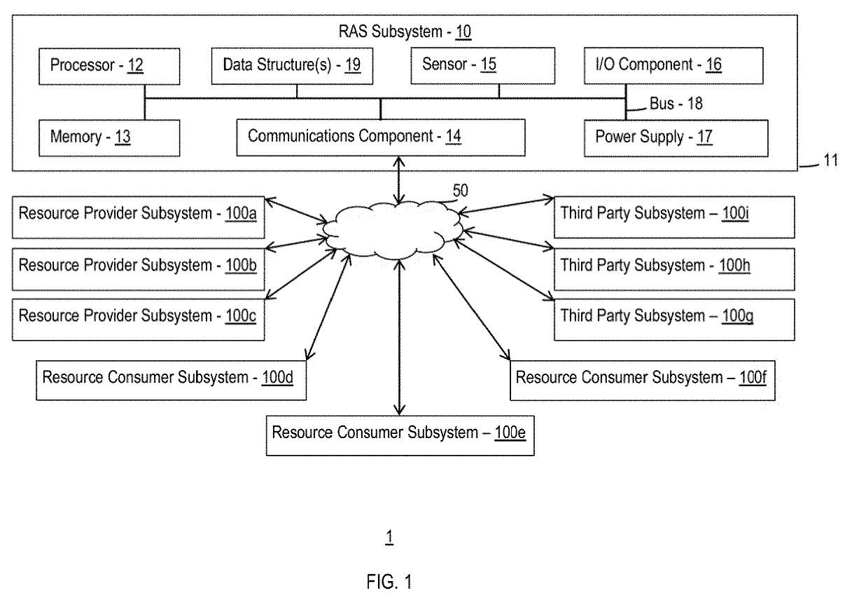

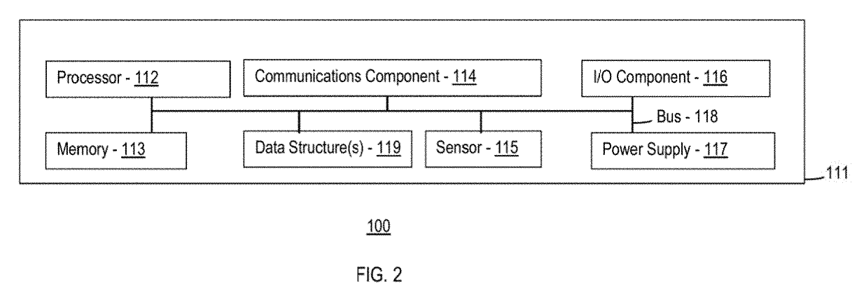

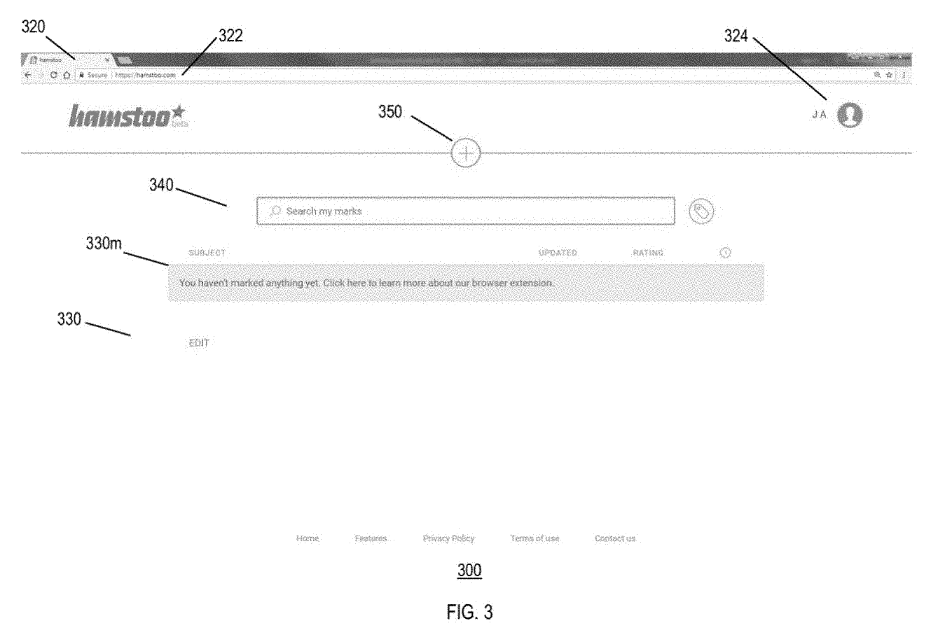

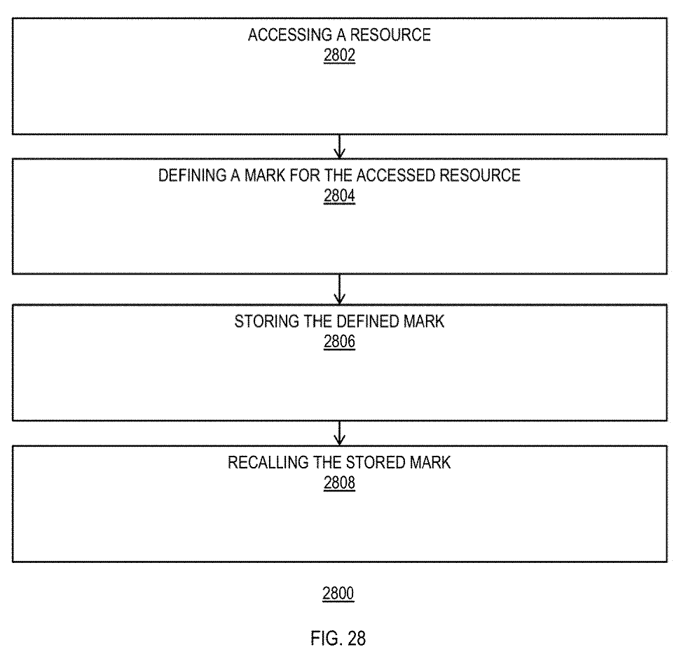

FIG. 1 shows a system 1 in which a resource accessibility service may be facilitated amongst various entities, FIG. 2 shows further details with respect to a particular embodiment of a subsystem of system 1, FIGS. 3-27 show illustrative screen shots of graphical user interfaces that may be presented to users of the system, and FIG. 28 is a flowchart of an illustrative process for providing features of the system.

### Description of FIG. 1 and FIG. 2

FIG. 1 is a schematic view of an illustrative system 1 in which a resource accessibility service may be facilitated amongst various entities. For example, as shown in FIG. 1, system 1 may include a resource accessibility service (“RAS”) subsystem 10, various subsystems 100 (e.g., one or more resource provider (“RP”) subsystems 100a-100c, one or more resource consumer (“RC”) subsystems 100d-100f, and/or one or more third party (“TP”) subsystems 100g-100i), and at least one communications network 50 through which any two or more of the subsystems 10 and 100 may communicate. RAS subsystem 10 may be operative to interact with any of the various subsystems 100 to provide a resource accessibility service platform (“RASP”) of system 1 that may facilitate various resource accessibility services, including, but not limited to, enabling users (e.g., resource consumers) to access any suitable resources (e.g., from resource providers) and to retain and retrieve previously accessed resources in an effective and efficient manner. It is to be understood that the term “Hamstoo” may be interchangeably used with the RASP or an operator entity of the RASP as a term generally referring to the system or platform and underlying technology and resource accessibility services of the disclosure (e.g., as operated by an operator of RAS subsystem 10).

As shown in FIG. 2, and as described in more detail below, a subsystem 100 may include a processor component 112, a memory component 113, a communications component 114, a sensor component 115, an input/output (“I/O”) component 116, a power supply component 117, and/or a bus 118 that may provide one or more wired or wireless communication links or paths for transferring data and/or power to, from, or between various other components of subsystem 100. I/O component 116 may include at least one input component (e.g., a button, mouse, keyboard, microphone, etc.) to receive information from a user of subsystem 100 and/or at least one output component (e.g., an audio speaker, video display, haptic component, etc.) to provide information to a user of subsystem 100, such as a touch screen that may receive input information through a user's touch on a touch sensitive portion of a display screen and that may also provide visual information to a user via that same display screen. Memory 113 may include one or more storage mediums, including for example, a hard-drive, flash memory, permanent memory such as read-only memory (“ROM”), semi-permanent memory such as random-access memory (“RAM”), any other suitable type of storage component, or any combination thereof. Communications component 114 may be provided to allow one subsystem 100 to communicate with a communications component of one or more other subsystems 100 or subsystem 10 or servers using any suitable communications protocol (e.g., via communications network 50). Communications component 114 can be operative to create or connect to a communications network for enabling such communication. Communications component 114 can provide wireless communications using any suitable short-range or long-range communications protocol, such as Wi-Fi (e.g., an 802.11 protocol), Bluetooth, radio frequency systems (e.g., 1200 MHz, 2.4 GHz, and 5.6 GHz communication systems), infrared, protocols used by wireless and cellular telephones and personal e-mail devices, or any other protocol supporting wireless communications. Communications component 114 can also be operative to connect to a wired communications network or directly to another data source wirelessly or via one or more wired connections or a combination thereof. Such communication may be over the internet or any suitable public and/or private network or combination of networks (e.g., one or more networks 50). Sensor 115 may be any suitable sensor that may be configured to sense any suitable data from an external environment of subsystem 100 or from within or internal to subsystem 100 (e.g., light data via a light sensor, audio data via an audio sensor, location-based data via a location-based sensor system (e.g., a global positioning system (“GPS”)), etc.). Power supply 117 can include any suitable circuitry for receiving and/or generating power, and for providing such power to one or more of the other components of subsystem 100. Subsystem 100 may also be provided with a housing 111 that may at least partially enclose one or more of the components of subsystem 100 for protection from debris and other degrading forces external to subsystem 100. Each component of subsystem 100 may be included in the same housing 111 (e.g., as a single unitary device, such as a laptop computer or portable media device) and/or different components may be provided in different housings (e.g., a keyboard input component may be provided in a first housing that may be communicatively coupled to a processor component and a display output component that may be provided in a second housing, and/or multiple servers may be communicatively coupled to provide for a particular subsystem). In some embodiments, subsystem 100 may include other components not combined or included in those shown or several instances of the components shown.

Processor 112 may be used to run one or more applications, such as an application that may be provided as at least a part of one data structure 119 that may be accessible from memory 113 and/or from any other suitable source (e.g., from RAS subsystem 10 via an active internet connection). Such an application data structure 119 may include, but is not limited to, one or more operating system applications, firmware applications, communication applications, internet browsing applications (e.g., for interacting with a website provided by RAS subsystem 10 for enabling subsystem 100 to interact with an online service of RAS subsystem 10 (e.g., a RASP)), RAS applications (e.g., a web application or a native application or a hybrid application that may be at least partially produced by RAS subsystem 10 for enabling subsystem 100 to interact with an online service of RAS subsystem 10 (e.g., a RASP)), or any other suitable applications. For example, processor 102 may load an application data structure 119 as a user interface program to determine how instructions or data received via an input component of I/O component 116 or via communications component 114 or via sensor component 115 or via any other component of subsystem 100 may manipulate the way in which information may be stored and/or provided to a user via an output component of I/O component 116 and/or to any other subsystem via communications component 114. As one example, an application data structure 119 may provide a user with the ability to interact with a resource accessibility service of the RASP of RAS subsystem 10, where such an application 119 may be an RAS application that may be running on subsystem 100 (e.g., an application associated with RAS subsystem 10 that may be loaded on subsystem 100 from RAS subsystem 10 or via an application market (e.g., the App Store™ by Apple Inc.)) and/or that may be accessed via an internet application or web browser running on subsystem 100 (e.g., processor 112) that may be pointed to a uniform resource locator (“URL”) whose target or web resource may be managed by RAS subsystem 10 or any other remote subsystem (e.g., as a RA browser extension (e.g., plug-in) associated with or managed by RAS subsystem 10 that may be extending the functionality of an internet application or web browser or other suitable resource browser that may be pointed to a URL or uniform resource indicator (“URI”) or file descriptor (“FD”) or reference whose target or resource may be managed by any suitable subsystem (e.g., a particular one of resource provider subsystems 100a-100c)). Each subsystem 100 may be a portable media device (e.g., a smartphone), a laptop computer, a tablet computer, a desktop computer, an appliance, a wearable electronic device, an implantable electronic device, an augmented reality device, a virtual reality device, at least one web or network server (e.g., for hosting and sharing any suitable resource and/or any suitable RAS application, for presentation on one or more other subsystems) with an interface for an administrator of such a server, and/or the like.

RAS subsystem 10 may include a housing 11 that may be similar to housing 111, a processor component 12 that may be similar to processor 112, a memory component 13 that may be similar to memory component 113, a communications component 14 that may be similar to communications component 114, a sensor component 15 that may be similar to sensor component 115, an I/O component 16 that may be similar to I/O component 116, a power supply component 17 that may be similar to power supply component 117, and/or a bus 18 that may be similar to bus 118. Moreover, RAS subsystem 10 may include one or more data sources or data structures or applications 19 that may include any suitable data or one or more applications (e.g., any application similar to application 119) for facilitating a resource accessibility service or RASP that may be provided by RAS subsystem 10 in conjunction with one or more subsystems 100. Some or all portions of RAS subsystem 10 may be operated, managed, or otherwise at least partially controlled by an entity (e.g., administrator) responsible for providing a resource accessibility service to one or more clients (e.g., end users or resource consumers) or other suitable entities.

RAS subsystem 10 may communicate with one or more subsystems 100 via communications network 50. Network 50 may be the internet or any other suitable network, such that when intercoupled via network 50, any two subsystems of system 1 may be operative to communicate with one another (e.g., a subsystem 100 may access information (e.g., from a data structure 19 of RAS subsystem 10, as may be provided as a resource accessibility service via processor 12 and communications component 14 of RAS subsystem 10) as if such information were stored locally at that subsystem 100 (e.g., in memory component 113)).

Various clients and/or partners may be enabled to interact with RAS subsystem 10 for enabling the resource accessibility services and the RASP. For example, at least one resource provider subsystem of system 1 (e.g., each one of the one or more resource provider subsystems 100a-100c) may be operated by any suitable resource provider (“RP”) in order to author, aggregate, publish, present, or otherwise make accessible any suitable content of any suitable resources (e.g., text, audio, video, images, animations, interactive content, and/or any other suitable type of consumable content (e.g., media content), which may be editorial and/or promotional and/or any other suitable type in nature (e.g., weblog posts, professional news articles, advertisements, and the like)). For example, as described in more detail with respect to FIGS. 3-28, any suitable resource provider (e.g., a publisher or web hosting service) may operate any suitable RP subsystem (e.g., a server) to make accessible any suitable resource to any suitable end user (e.g., to host and then share resource content of any suitable resource with any suitable RC subsystem (e.g., via network 50)). At least one resource consumer subsystem of system 1 (e.g., each one of the one or more resource consumer subsystems 100d-100f) may be operated by any suitable resource consumer (“RC”) in order to access and consume or otherwise be exposed to any content of any resource provided by a RP subsystem and may be enabled by the RASP to perform one or more actions associated with that accessed resource content. For example, as described in more detail with respect to FIGS. 3-28, any suitable end user (e.g., a content consumer) may operate any suitable RC subsystem (e.g., a personal computer (e.g., a smart phone or tablet or laptop, etc.)) to access any suitable resource (e.g., a web resource from any suitable RP subsystem) and the RASP may enable the system to define a mark with any suitable mark data based on that access of the resource (e.g., user annotations, system access metadata, resource content retrieval data, etc.), where such mark data may be used to retain and retrieve the previously accessed resource in an effective and efficient manner. At least one third party subsystem of system 1 (e.g., each one of the one or more third party subsystems 100g-100i) may be operated by any suitable third party (“TP”) that may be operative to enable at least partially any suitable feature or service or operation provided by the RASP, such as a third party application or service provider that may be operative to process or provide any suitable subject matter. For example, a TP subsystem (e.g., a server or any other suitable electronic computing subsystem) may be operated or otherwise controlled by any suitable entity in any suitable manner for supporting RAS subsystem 10 in providing the RASP, including, but not limited to, financial institutions that may provide any suitable financial information or credit scores or transmit or receive payments of any suitable party, social networks that may provide any suitable connection information between various parties or characteristic data of one or more parties, government agencies/regulators, licensing bodies, third party advertisers, owners of relevant data, sellers of relevant goods/materials, providers of various services (e.g., audio to text transcription, language to language translation, media file reformatting, storage and hosting and serving of large amounts of data (e.g., a web hosting service), digital archiving of the world wide web (e.g., The Wayback Machine by the Internet Archive), etc.), and/or any other suitable third party service provider.

Each subsystem 100 of system 1 (e.g., each one of subsystems 100a-100i) may be operated by any suitable entity for interacting in any suitable way with RAS subsystem 10 (e.g., via network 50) for deriving value from and/or adding value to a service of the RASP of RAS subsystem 10. For example, a particular subsystem 100 may be a personal computing device operated by a client/partner entity that may receive any suitable data from RAS subsystem 10 related to any suitable resource accessibility service of the RASP (e.g., via network 50). Additionally or alternatively, a particular subsystem 100 may be a server operated by a client/partner entity that may upload or otherwise provide any suitable data to RAS subsystem 10 related to any suitable resource accessibility service of the RASP (e.g., via network 50).

### Description of FIGS. 3-27 and FIG. 28

To facilitate the following discussion regarding the operation of system 1 for providing a resource accessibility service with RAS subsystem 10 in conjunction with one or more subsystems 100, reference is made to one or more processes of FIG. 28, to various components of system 1 of the schematic diagrams of FIGS. 1 and 2, and to the views of the screens of FIGS. 3-27 that may be representative of a graphical user interface of a resource consumer subsystem 100d of one or more of FIGS. 1 and 2 presenting exemplary resource accessibility presentations 300-2700 of the resource accessibility service of the disclosure. FIG. 28 is a flowchart of an illustrative process 2800 for enabling a user of a resource consumer subsystem (e.g., at least one of RC subsystems 100d-100f) to interact with resource content and/or associated mark data using the RASP of a resource accessibility service subsystem (e.g., using an RAS application of RAS subsystem 10 that may be at least partially running on the RC subsystem and/or using any suitable RAS data provided by RAS subsystem 10), a resource provider subsystem (e.g., at least one of RP subsystems 100a-100c), and/or a third party subsystem (e.g., at least one of TP subsystems 100g-100i), while FIGS. 3-27 show respective resource accessibility presentations 300-2700 that may be provided as a graphical user interface on the RC subsystem (e.g., during process 2800). The operations described with respect to process 2800 of FIG. 28 may be achieved with a wide variety of graphical elements and visual schemes. Therefore, the embodiments of FIGS. 3-27 are not intended to be limited to the precise user interface conventions adopted herein. Rather, embodiments may include a wide variety of user interface styles and options. Alternatively, one, some, or each operation described with respect to process 2800 of FIG. 28 may be achieved without any graphical elements or visual schemes but, instead, may be achieved using audible and/or tactile and/or any other suitable presentation techniques.

For example, as shown in FIG. 3, a graphical user interface (“GUI”) of a resource consumer subsystem may be configured to display (e.g., on an output component 116 of RC subsystem 100d) resource accessibility presentation 300, which may be a landing presentation or introduction when a user initially accesses a user RAS application (“user RAS app”) of the RASP. In some embodiments, the user RAS application may be interfaced with by a user or resource consumer on any suitable I/O component 116 (e.g., a touch screen display) of resource consumer subsystem 100d, where the user RAS application may be stored locally on RC subsystem 100d (e.g., through download as an app from an app store or otherwise) and may be functional (e.g., at least partially functional) when RC subsystem 100d is not online (e.g., not communicatively coupled to RAS subsystem 10 (e.g., via network 50) and/or may be functional (e.g., more completely functional) when RC subsystem 100d is online (e.g., communicatively coupled to RAS subsystem 10 (e.g., via network 50) for actively affecting the user RAS app (e.g., a native application of the RAS subsystem or a web app or web browser pointing to a URL of a resource of the RAS subsystem that may be providing the user RAS app on RC subsystem 100d (e.g., as at least a portion of a data structure 119 of subsystem 100d)), where RAS subsystem 10 may be the source of the majority of the content of presentation 300. As shown by presentation 300, in one particular example, the user RAS app may be provided by a web browser tab 320 that may be pointed to a URL of a resource (e.g., a web resource on a RAS server) of the RAS subsystem that may be providing the user RAS app on RC subsystem 100d. As shown, presentation 300 may also include a header or URL or other RAS provider identifier 322 that may be operative to identify the resource providing the user RAS app and/or the entity managing the user RAS app (e.g., RAS subsystem 10) and/or to identify the user RAS app with which the user of RC subsystem 100d may be interfacing to experience presentation 300 of the user RAS app (e.g., Hamstoo.com by Hamstoo). Other suitable content, such as user identification content 324 may be provided by presentation 300 to identify a particular user or account manager (e.g., user “JA”) that has been authenticated by the user RAS application (e.g., through a log-in process to the user RAS app using a unique user identifier and password combination, after which presentation 300 may be provided). While authenticated (e.g., actively logged-in) for a particular user, the user RAS application may have access to certain data associated with that user and/or may behave according to certain settings customized by that user and/or may generate and/or store new data for association with that user.

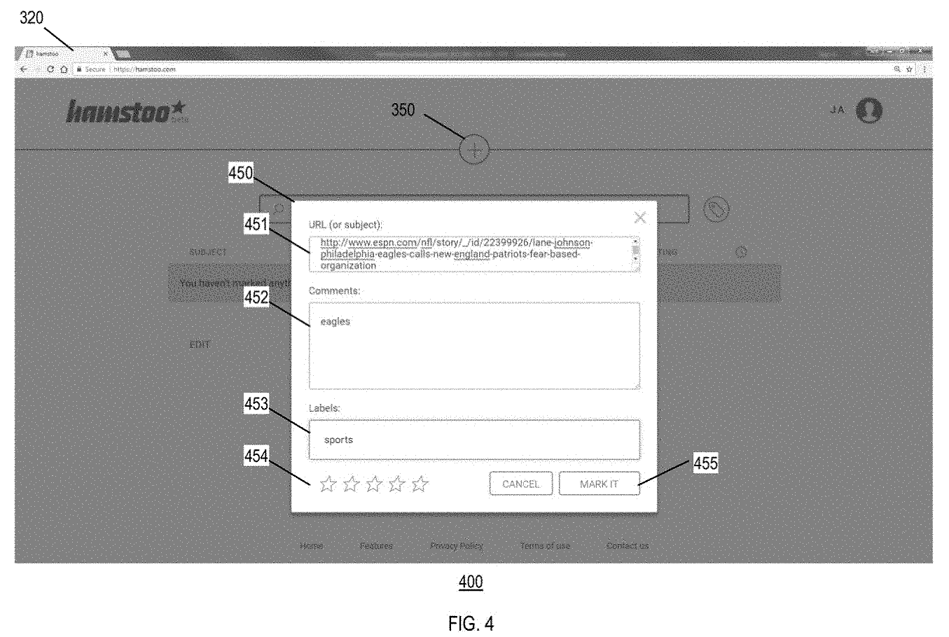

The user RAS app of the RASP may enable the system to define a mark with any suitable mark data based on any suitable resource that may be accessed by an RC subsystem utilizing the use RAS app, and the mark data of a defined mark may then be used by the user RAS app to retain and/or retrieve the previously accessed resource associated with that mark. This may enable a user to effectively and efficiently retain and retrieve and annotate experiences with various resources. Therefore, as shown, presentation 300 may also include a mark listing interface region 330 that may be operative to include a listing or any other suitable presentation of any marks associated with the user (e.g., authenticated user JA). However, as shown in FIG. 3, mark interface region 330 may not include any listed marks, as no marks have been created yet for the user (e.g., as may be indicated by any suitable message 330m (e.g., “You haven't marked anything yet . . .”). Additionally or alternatively, as shown, presentation 300 may also include a mark searching interface region 340 that may be operative to enable any suitable searching techniques for searching through and/or filtering and/or probing and/or otherwise manipulating the user's marks (e.g., for identifying or retrieving a particular resource) using any suitable mark data associated with the user's marks. Additionally or alternatively, as shown, presentation 300 may also include a mark adding interface region 350 (e.g., a selectable radio button with a “+” sign indicator) that may be operative to enable a user to initiate the creation of a new mark. Any other suitable content may be additionally or alternatively provided by such an introduction presentation 300 (e.g., at the discretion of creator of the user RAS app and/or based on any userspecific customizations). As described herein, presentation 300 of FIG. 3 as well as presentations 400-2700 of FIGS. 4-27 may include various user interface elements. Additionally or alternatively, various other types of non-visual information may be provided to a user via various other I/O components 116 of RC subsystem 100d (e.g., audible and/or haptic information that may be operative to convey any suitable information)).

FIG. 28 is a flowchart of an illustrative process 2800 for enabling a user of a resource consumer subsystem (e.g., RC subsystem 100d) to interact with resource content and/or associated mark data (e.g., via resource accessibility presentations 300-2700 of FIGS. 3-27) using the RASP of a resource accessibility service subsystem (e.g., using a user RAS application of RAS subsystem 10 that may be at least partially running on the RC subsystem and/or using any suitable RAS data provided by RAS subsystem 10), a resource provider subsystem (e.g., at least one of RP subsystems 100a-100c), and/or a third party subsystem (e.g., at least one of TP subsystems 100g-100i). At operation 2802 of process 2800, content of an identified resource may be accessed (e.g., any suitable resource may be identified in any suitable manner by the RASP and any suitable content of that identified resource may be accessed by the RASP). At operation 2804 of process 2800, a mark may be defined (e.g., by the RASP) for the accessed resource (i.e., the resource accessed at operation 2802), wherein the mark may be defined to include mark data that may include (i) resource content retrieval data that may be operative to provide at least a portion of the content of the resource, and one or both of (ii) system metadata associated with the accessing of the resource and (iii) user annotation data associated with a user's reaction to the accessed resource. At operation 2806 of process 2800, the defined mark (i.e., the mark defined at operation 2804) may be stored (e.g., by the RASP). At operation 2808 of process 2800, the stored mark (i.e., the mark stored at operation 2806) may be recalled (e.g., by the RASP).

For example, such a resource that may be accessed (e.g., at operation 2802 of process 2800) may be any suitable resource, including, but not limited to, a web resource, web page, web document, system resource, computer file, computer resource, or the like that may be hosted by and accessed from or otherwise provided by any suitable RP subsystem or even any suitable RC subsystem. As one example, such a resource may be any suitable web resource that may include any suitable web resource elements, such as one or more style sheets, scripts, and/or images (e.g., any suitable elements of any suitable web page) that may be hosted and provided by any suitable RP subsystem (e.g., RP subsystem 100a). As another example, such a resource may be any suitable computer file resource that may include any suitable computer file resource elements, such as a word processor document (e.g., a “.doc” file type) that may include text elements, an image file (e.g., a “.jpeg” file type), a video file, an audio file, any other suitable media file, and/or the like, that may be hosted and provided by any suitable RP subsystem (e.g., RP subsystem 100a) or by any suitable RC subsystem (e.g., RC subsystem 100d that may also be used by a user to identify the resource to the RASP (e.g., for having an associated mark defined and/or updated and/or retrieved and/or the like for the identified resource). For example, any RP subsystem may generate, curate, compile, or otherwise provide any suitable content of any suitable resource of any suitable type (e.g., at least one resource with text content, audio content, video content, visual content, and/or the like). In some embodiments, a resource provider may be a journalistic website, such as huffingtonpost.com or any other suitable online media provider, a content aggregator, such as YouTube.com for videos or EarWolf.com for audio podcasts or any other collector of any suitable type(s) of user generated content, or any other suitable online provider of any suitable content. Any such resource may be identified by the RASP in any suitable manner such that the resource may be accessed by the RASP (e.g., at operation 2802). For example, any suitable resource identifier, such as a uniform resource indictor (“URI”), uniform resource locator (“URL”), web address, hyperlink, file descriptor (“FD”), handle, reference, or the like for identifying any suitable type of resource may be provided to or received by or otherwise obtained by the RASP for use in accessing any suitable content of the resource identified by the resource identifier.

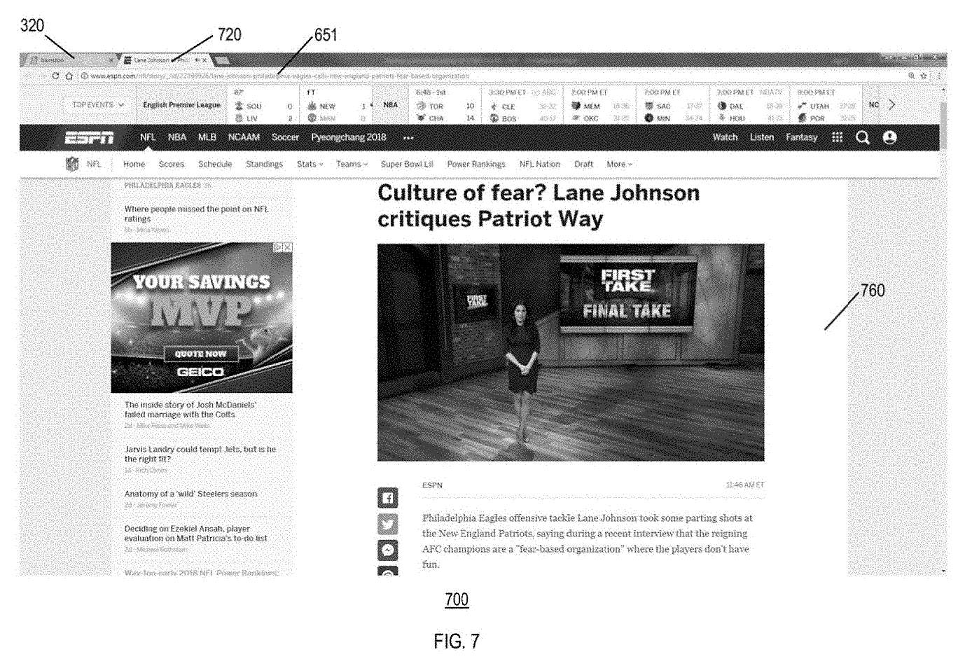

As shown by presentation 400 of FIG. 4, for example, a mark defining interface region 450 may be provided (e.g., as a pop-up window in response to selection of the radio button option of mark adding interface region 350 of presentation 300 of FIG. 3), and mark defining interface region 450 may be operative to enable a user to initiate the creation of a new mark by identifying a resource with which the new mark is to be associated and defined. Mark defining interface region 450 may include a resource identifier region 451 in which a particular resource identifier for a particular resource may be provided (e.g., by a user of RC subsystem 100d (e.g., using any suitable input component of I/O component 116)). As shown, a particular URL to a particular web resource may be provided (e.g., typed or dictated or pasted) into resource identifier region 451 (e.g., by a user of RC subsystem 100d) for identifying the web resource (e.g., a user may have accessed a particular web resource via a web browser tab other than web browser tab 320 (see, e.g., tab 720 of FIG. 7) and may then copy the URL for that particular accessed web resource from the other web browser tab and may then paste that copied URL into resource identifier region 451 of web browser tab 320). Alternatively, a user could drag and drop a file stored on RC subsystem 100d into region 451 or otherwise identify the location of such a file (e.g., an image file, an audio file, a video file, etc.). Mark defining interface region 450 may also include a comments region 452 in which any suitable comments may be entered for use in at least partially defining user annotation data (e.g., for defining mark data of the mark to be created). Such comments may be any suitable comments (e.g., textual, audible, graphical, etc.) that the user may convey (e.g., for indicating any suitable user reaction to the resource (e.g., the resource identified in region 451)). For example, such comments may include a user's thoughts on the content of the resource, or the user's reasoning for defining a mark for the resource, and/or any other suitable comments. Additionally or alternatively, mark defining interface region 450 may also include a labels region 453 in which any suitable labels may be entered or selected for use in at least partially defining user annotation data (e.g., for defining mark data of the mark to be created). Such labels may be any suitable labels (e.g., new or predefined) that the user may wish to associate with the resource being marked (e.g., for indicating any suitable user reaction to the resource (e.g., the resource identified in region 451)). Additionally or alternatively, mark defining interface region 450 may also include a ratings interface 454 in which any suitable rating or ranking may be entered or selected for use in at least partially defining user annotation data (e.g., for defining mark data of the mark to be created). Such a rating may be any suitable format (e.g., 1-5 stars, different emojis, a sliding scale bar, etc.) that the user may wish to associate with the resource being marked (e.g., for indicating any suitable user reaction to the resource (e.g., the resource identified in region 451)). Moreover, as shown, mark defining interface region 450 may include a mark define command interface or radio button 455 that may be selected to further the process of defining a mark for the resource identified in region 451. In response to selection of mark define command interface 455, a mark may be defined and stored for the resource identified in region 451 (e.g., by operations 2804 and 2806), either exclusively by RC subsystem 100d (e.g., if RC subsystem 100d is offline and/or if the identified resource is local to RC subsystem 100d, etc.) or in conjunction with an appropriate RP subsystem (e.g., RP subsystem 100a) that may be hosting and operative to share content of the identified resource with the RASP and/or in conjunction with RAS subsystem 10 that may be operative to at least partially define mark data of the mark being defined and/or at least partially store mark data of the defined mark.

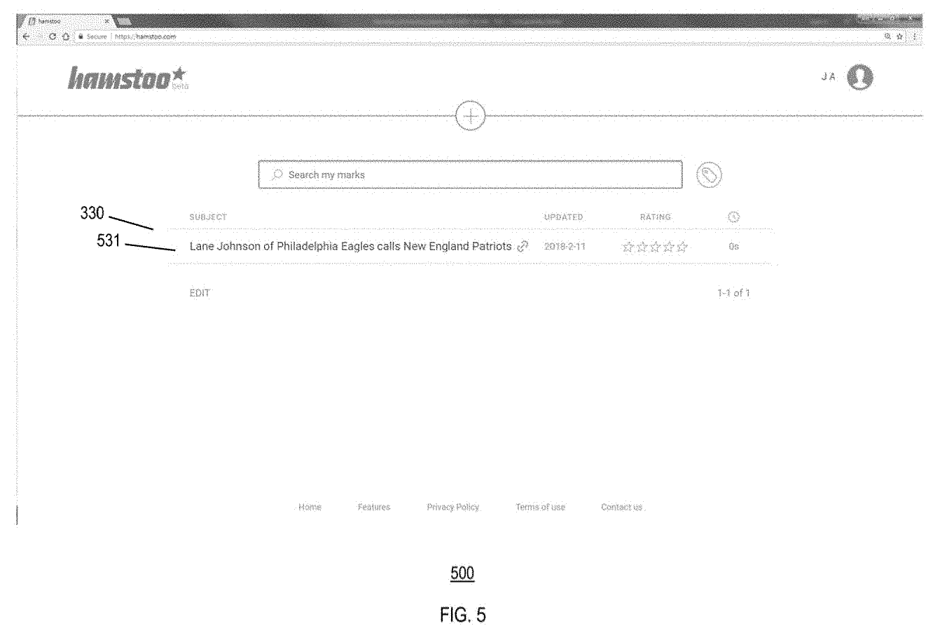

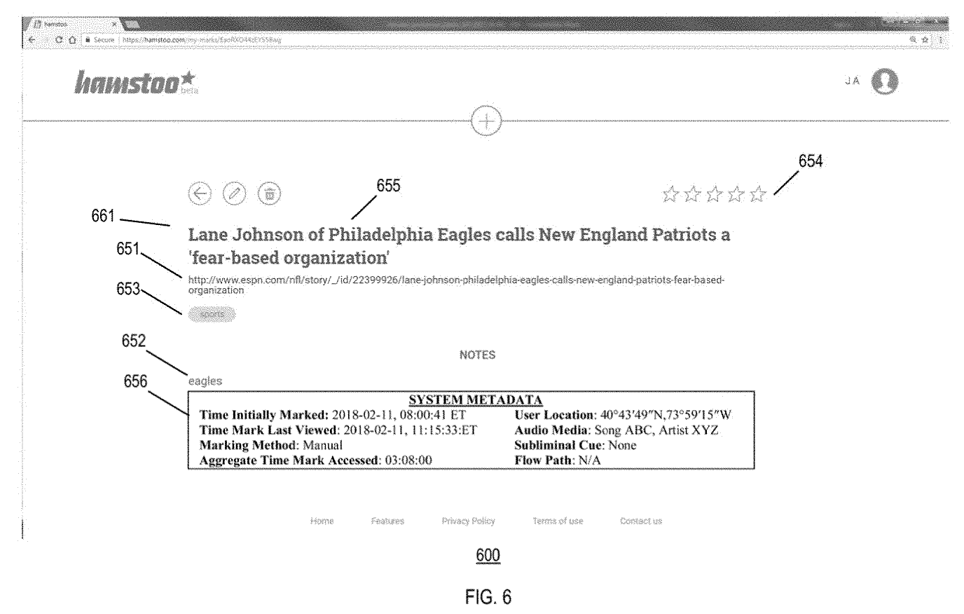

As shown by presentation 500 of FIG. 5, for example, mark listing interface region 330 may be updated to include a mark listing 531 that may be indicative of a mark defined for the resource identified in region 451 of interface 450 (e.g., in response to selection of mark define command interface 455). Mark listing 531 may include any suitable data indicative of the mark, including, but not limited to, a subject or title for the mark (e.g., a title of the underlying resource, as may be derived from the content of the resource itself, the resource indictor, any suitable user provided user annotation data, and/or any other suitable data), a clickable link icon that may be selectable to open or access the resource associated with the mark, a date at which the mark was created or last updated, a rating of the mark, a duration of time in which the mark was defined, and/or the like. Mark listing 531 may be selectable for opening a more detailed view of the mark. Therefore, the defined and stored mark may be recalled (e.g., at operation 2808). For example, as shown by presentation 600 of FIG. 6, a first illustrative detailed mark interface 661 may be presented in response to a user selecting mark listing 531 for further detail. As shown, detailed mark interface 661 may include a subject or title 655 for the mark (e.g., a title of the underlying resource, as may be derived from the content of the resource itself, the resource indictor, any suitable user provided user annotation data, and/or any other suitable data). Detailed mark interface 661 may include a resource identifier 651 for the resource of the mark (e.g., the resource identifier provided into resource identifier region 451 (e.g., by a user of RC subsystem 100d) for identifying the web resource at presentation 400 for defining the mark). Detailed mark interface 661 may include one or more comments 652 for the resource of the mark (e.g., the comment(s) provided into comments region 452 (e.g., by a user of RC subsystem 100d) for at least partially defining user annotation data for the mark at presentation 400). Detailed mark interface 661 may include one or more labels 653 for the resource of the mark (e.g., the label(s) provided into labels region 453 (e.g., by a user of RC subsystem 100d) for at least partially defining user annotation data for the mark at presentation 400). Detailed mark interface 661 may include one or more ratings 654 for the resource of the mark (e.g., the rating provided into ratings interface 454 (e.g., by a user of RC subsystem 100d) for at least partially defining user annotation data for the mark at presentation 400). In addition to or as an alternative to any suitable user annotation data (e.g., comments 652, labels 653, ratings 654, etc.), the defined mark detailed by detailed mark interface 661 may include any suitable system metadata 656 that may be automatically detected by the RASP (e.g., by RC subsystem 100d or otherwise), including, but not limited to, a time at which the resource was initially marked (e.g., at which the mark was initially defined), the time at which the mark (and/or the associated resource's content) was last viewed by the user, the method by which the resource was identified for marking (e.g., manually by the user (e.g., at presentation 400) or automatically or otherwise), an aggregate amount of time during which the resource's content was accessed by the user, a location of the user (e.g., a location of RC subsystem 100d (e.g., as detected by a GPS sensor component 115)) when the mark was initially defined, identification of any audio media being played back by the user when the mark was initially defined (e.g., audio being played back (e.g., by a music app) independently of the accessing of the marked resource), any subliminal cues associated with the marked resource, a flow path associated with the marked resource (e.g., another resource with a link that was used to access the resource for defining the mark and/or another resource that was accessed by a link in the marked resource), the number of times the mark and/or associated resource content has been viewed by the user (e.g., duration of resource access overall or per word of resource content, etc.), the number of times the mark has been shared by the user, the number of times the mark has been identified in a search for recall by the user, predominant color scheme of the content, number and/or size of any images in the content, existence of Flash or other types of data in the content, such as audio or video playback, and/or the like. All of such system metadata may be automatically determined by the RASP and used to automatically define at least a portion of the mark data of a defined mark, and such system data of a defined mark may then be used to carry out any suitable mark searches for enabling efficient and effective resource recall.

In some embodiments, resource identifier 651 for the resource of the mark (e.g., the resource identifier provided into resource identifier region 451 (e.g., by a user of RC subsystem 100d) for identifying the web resource at presentation 400 for defining the mark) may be the only resource content retrieval data of the mark data of the defined mark. That is, resource identifier 651 may be the only data stored as a portion of the mark data of the defined mark that may be used to provide at least a portion of the content of the resource associated with the defined mark. In such instances, a user may select (e.g., click on) or otherwise use such a resource identifier to re-access the content of the resource. For example, resource identifier 651 may be a clickable URL that may be selected or otherwise used from presentation 600 to re-access the resource content of the defined mark, such as by opening a new web browser tab 720 (e.g., adjacent web browser tab 320 of the user RSA app) that may be pointed to the URL resource identifier 651 for presenting content 760 of the resource associated with the defined mark in a presentation 700 of FIG. 7)). Therefore, the defined mark may include resource content retrieval data (e.g., resource identifier 651) that may be used by a user of the RASP to re-access the resource of the mark when the mark is provided to the user.

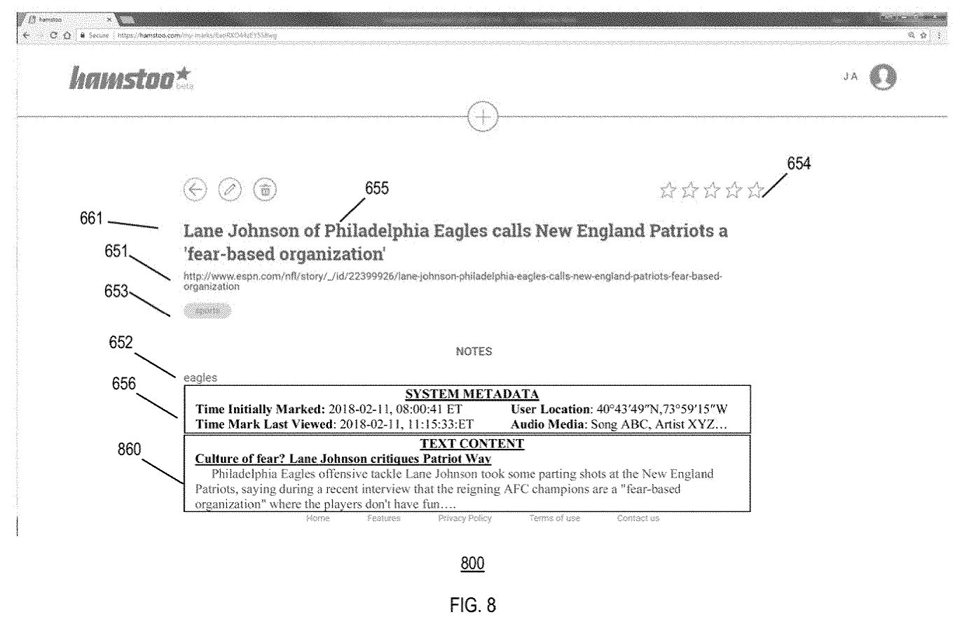

In some embodiments, the defined mark may include any alternative or any additional resource content retrieval data for the resource of the mark besides resource identifier 651. As shown in FIG. 8, a presentation 800 may be similar to presentation 600 but may also include text only content 860 that may be indicative of all of the text content of the resource associated with the defined mark (e.g., the text content of content 760 of presentation 700 (e.g., through any suitable optical character recognition processes or any other suitable processes for capturing such text data of the resource)). The RASP may be operative to identify such text when the resource was initially accessed (e.g., at operation 2802) and to use such identified text to define at least a portion of resource content retrieval data of the mark data when the mark was defined and stored (e.g., at operations 2804 and 2806). Such text only content 860 may be stored as a portion of the mark data of the defined mark (e.g., on RC subsystem 100d and/or on RAS subsystem 10 or otherwise) for recall whenever requested by the user, such that the original source of the resource accessed at operation 2802 (e.g., RP subsystem 100a) need not be utilized to access such text only content 860 at operation 2808, which may be helpful if RC subsystem 100d is no longer able to be communicatively coupled to that RP subsystem at operation 2808 and/or if that RP subsystem has updated the resource since it was accessed at operation 2802.

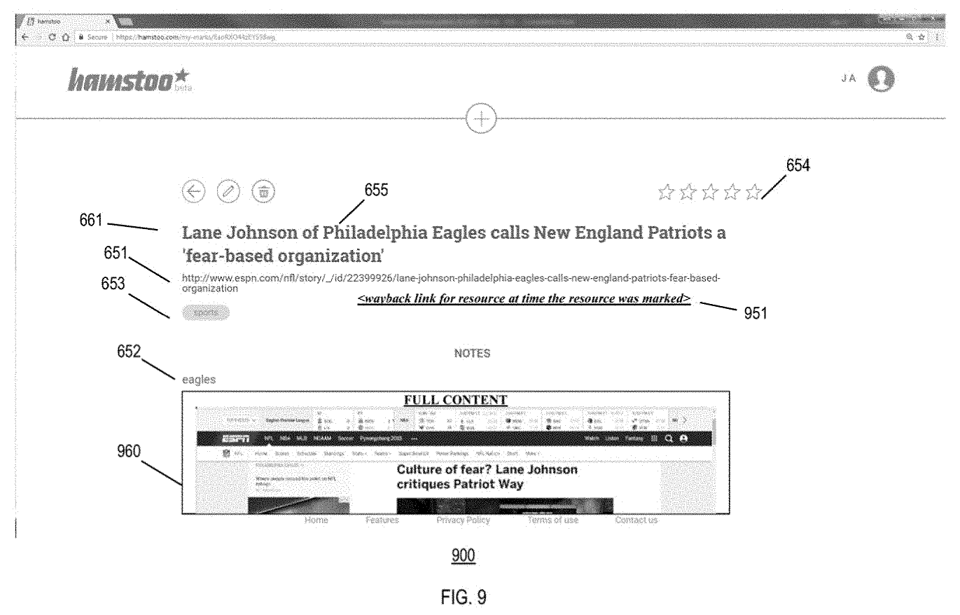

In some embodiments, the defined mark may include any alternative or any additional resource content retrieval data for the resource of the mark besides resource identifier 651 and/or besides text only content 860. As shown in FIG. 9, a presentation 900 may be similar to presentation 600 but may also include full content 960 that may be indicative of all of the content of the resource associated with the defined mark (e.g., all of the content of content 760 of presentation 700). The RASP may be operative to identify and store all of such content when the resource was initially accessed (e.g., at operation 2802) and to use such identified full content to define at least a portion of resource content retrieval data of the mark data when the mark was defined and stored (e.g., at operations 2804 and 2806). Such full content 960 may be stored as a portion of the mark data of the defined mark (e.g., on RC subsystem 100d and/or on RAS subsystem 10 or otherwise) for recall whenever requested by the user, such that the original source of the resource accessed at operation 2802 (e.g., RP subsystem 100a) need not be utilized to access such full content 960 at operation 2808, which may be helpful if RC subsystem 100d is no longer able to be communicatively coupled to that RP subsystem at operation 2808 and/or if that RP subsystem has updated the resource since it was accessed at operation 2802. Additionally or alternatively, the defined mark may include any alternative or any additional resource content retrieval data for the resource of the mark besides resource identifier 651 and/or besides text only content 860 and/or besides full content 960. For example, as shown in presentation 900 of FIG. 9, an archived content link 951 may be provided that may be similar to resource identifier 651 but for the resource at a particular moment in time (e.g., the time at which the resource was marked (e.g., the time of operation 2802) (e.g., a link similar to those provided by the Way Back Machine by the Internet Archive)), such that link 951 may be used to re-access the same resource content at the time of operation 2808 as was accessed at the time of operation 2802 even if link 651 does not access the same resource content (e.g., if the RP subsystem has updated the resource at link 651 since the time it was accessed at operation 2802). Anyone of presentations 600, 800, and 900 may be operative to enable a user to edit any suitable characteristics of the defined mark, such as by adding any new user annotation data, editing or deleting any existing user annotation data, or deleting the entire mark.

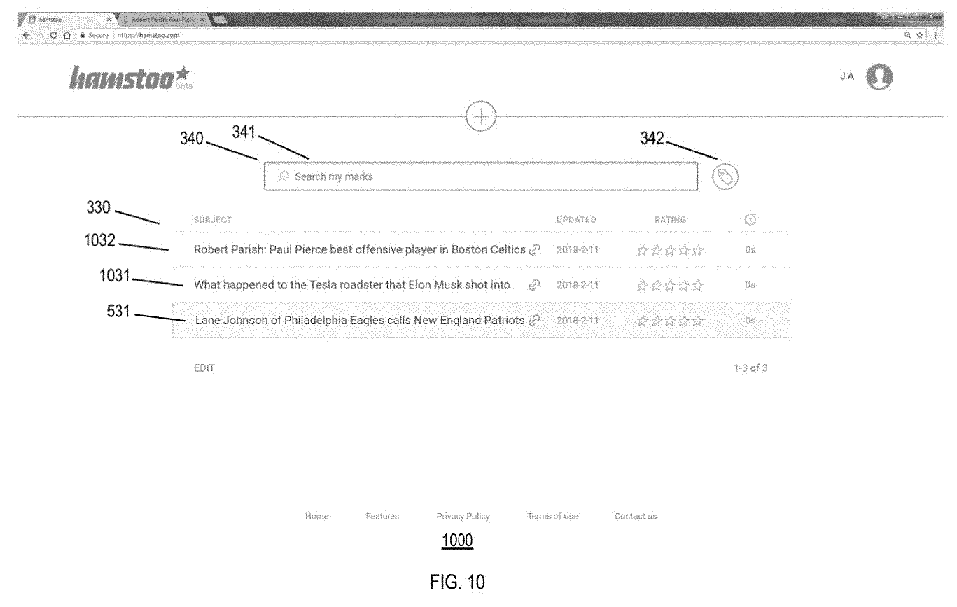

Operations 2802-2806 of process 2800 of FIG. 28 may be repeated for accessing different resources and defining a mark for each accessed resource. For example, as shown by presentation 1000 of FIG. 10, mark listing interface region 330 may be updated to include not only mark listing 531, but also additional mark listings, such as mark listings 1031 and 1032, each of which may be indicative of a mark defined for a respective resource. Each one of mark listings 1031 and 1032 may be selected for opening a new detailed view of the mark, as described with respect to mark listing 531 and FIGS. 6-9, and/or interacted with in any other suitable manner. The mark listings of listing interface region 330 may be selectively ordered in any suitable manner (e.g., through user selection or otherwise), such as alphabetically by subject, chronologically by the date at which the marks of the listings were defined, by rating level, by duration of time in which the marks were defined, and/or the like. Therefore, listing interface region 330 may provide a snap shot of an overall history of the user's experiences with various accessed resources.

In addition to presentation 1000 presenting a user with a listing of all defined marks that may be sorted in any suitable manner and/or that may be used to select a particular mark for opening a more detailed view of the mark's underlying mark data, presentation may also include mark searching interface region 340 that may include any suitable tools that may be operative to enable any suitable searching techniques for searching through and/or filtering and/or probing and/or otherwise manipulating the user's marks (e.g., for identifying or retrieving a particular resource) using any suitable mark data associated with the user's marks. For example, as shown, mark searching interface region 340 may include a text search bar 341 in which a user may enter any suitable text to be searched in a database (e.g., a database of mark data for the marks that have been defined and stored for the user). Multiple search terms may be combined together in any suitable manner (e.g., with Boolean operators) to for a more complex query. For example, text search bar 341 may be used to define and order a search for particular text in particular types of mark data, such as a search for the text “ABC” in the system metadata (e.g., in the audio media system metadata) of all marks and a search for the text “champions” in the resource content retrieval data of all marks, which would result in an identification of at least the mark associated with mark listing 531 (see, e.g., presentation 800 where the text “ABC” exists in system metadata 656 and the text “champions” exists in content 860 of that mark).

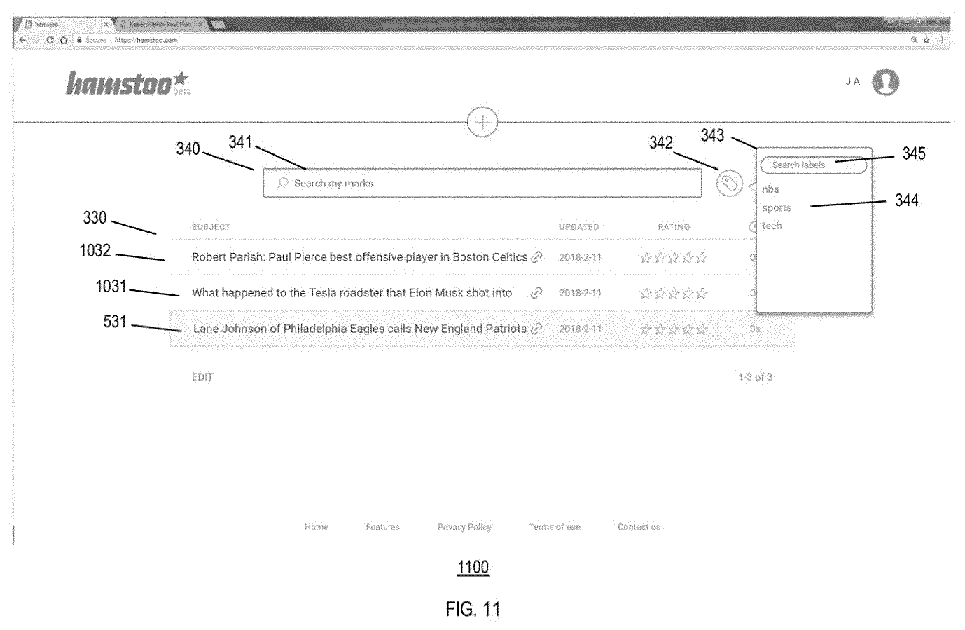

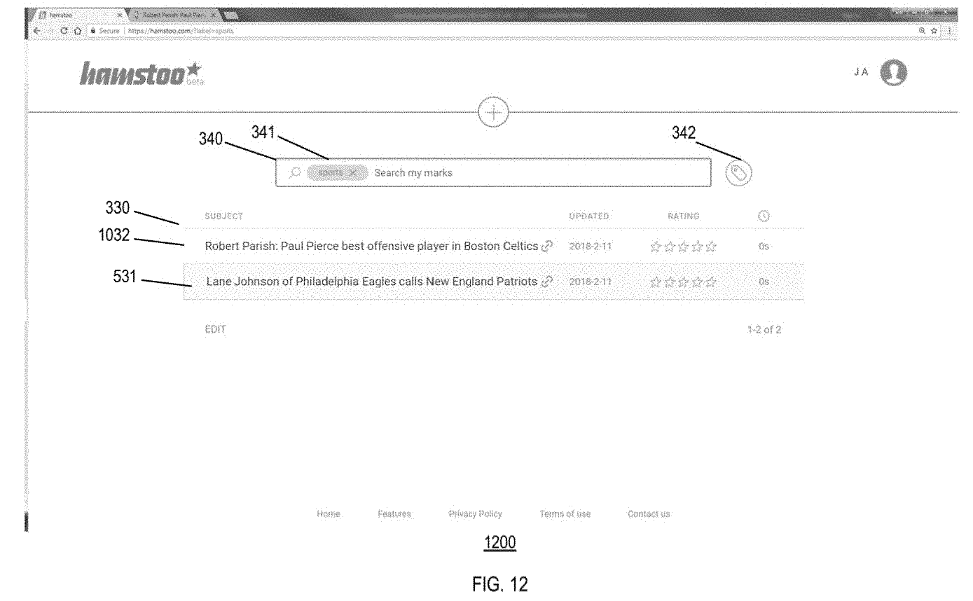

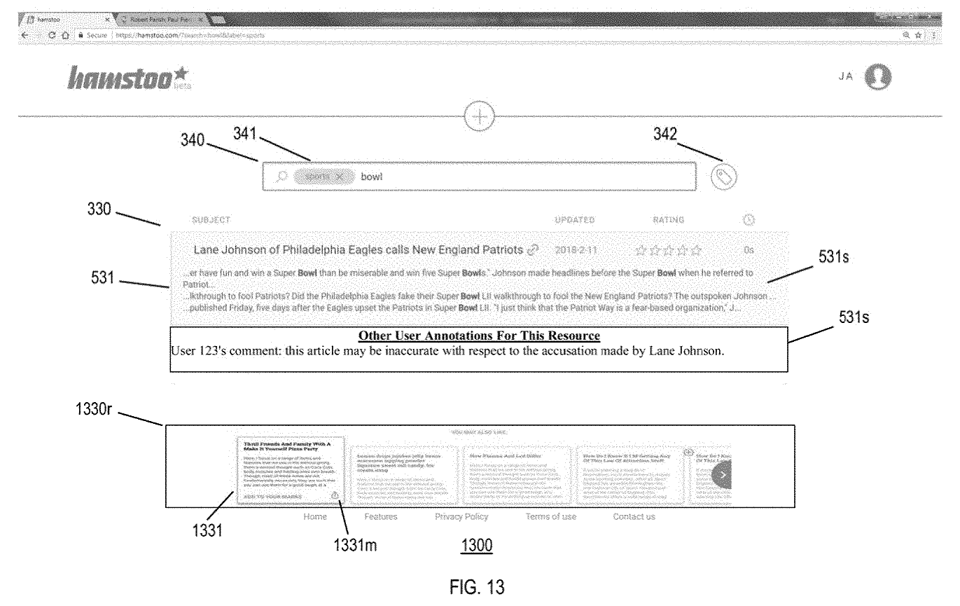

In addition to presenting text search bar 341, mark searching interface region 340 may include a label filter 342. For example, as shown by presentation 1100 of FIG. 11, in response to user selection of label filter 342, a label pop-up box or other suitable label searching interface 343 may be provided that may include a listing 344 of all labels defined by the mark data of the user's marks from which a user may select one or more labels to refine a mark search being defined by mark searching interface region 340. Additionally or alternatively, label searching interface 343 may include a text label search bar 345 that may be used to textually search for one or more labels to be selected for refining the mark search. For example, as shown by presentation 1200 of FIG. 12, in response to a “sports” label being selected via user interaction with label searching interface 343, that “sports” label may be inserted into text search bar 341 as a specific label search term. In some embodiments, text search bar 341 may be configured to send automatically any entered search terms for search and to present the user with real-time search results, whereby, for example, in response to the “sports” label being selected via user interaction with label searching interface 343 for entry into search bar 341, all label user annotation data of all mark data may be automatically searched in order to identify which, if any, marks include user annotation data defining a “sports” label. As shown by presentation 1200, mark listing interface region 330 may be automatically updated to include only the mark listings associated with marks that may include mark data with user annotation data defining a “sports” label, such as to include only mark listings 531 and 1032, but not mark listing 1031. Continuing with this example, as shown by presentation 1300 of FIG. 13, if a user were then also to add a generic search term of text “bowl” to search bar 341 in addition to the already provided “sports” label search feature, all mark data may be automatically searched in order to identify which, if any, marks include not only user annotation data defining a “sports” label but also any mark data including the term “bowl”, whereby mark listing interface region 330 may be automatically updated to include only the mark listings associated with marks that may include mark data with user annotation data defining a “sports” label and mark data including the term “bowl”, such as to include only mark listing 531, but not mark listings 1031 and 1032. Furthermore, in some embodiments, when a general text search term, such as “bowl” in this example, may be provided in search bar 341, any mark listing results may be enhanced with mark listing search term enhancement data. For example, as shown by presentation 1300, when mark listing 531 is identified to meet the search requirements of mark searching interface region 340, mark listing 531 provided within mark listing interface region 330 may be enhanced with mark listing search term enhancement data 531s, which may identify each instance of a search term as it appears in the mark data of the mark associated with mark listing 531 (e.g., each snippet of text from the mark data that includes the term “bowl” may be quoted by enhancement data 531s to provide some context to the user within mark listing interface region 330, such that the user does not have to select the mark listing to access detailed mark interface 661 of presentation 600, 800, or 900 for gaining further information as to why the mark of mark listing 531 survived the search). Therefore, any search provided by user interaction with mark searching interface region 340 may be operative to enable one or more defined and stored marks to be recalled (e.g., at operation 2808). In some embodiments, as shown, annotation data made by other users of the RASP with respect to the same resource of a listed mark may be provided by presentation 1300 (e.g., as shown by other user annotation data 531u for mark listing 531), where the other users may be chosen from all users of the RASP or only users of the RASP within the user's social network.

In response to any suitable search, the RASP may be configured to serve up one or more additional recommended resources, other than the resource(s) of the mark(s) that survived the search. For example, as shown by presentation 1300, a recommendation interface region 1330r may be provided that includes at least a snippet of content of one or more additional resources that may be of interest to the user based on the user's search and/or based on the existing user marks that survived the user's search. As shown, a recommended resource 1331 of recommendation interface region 1330r may include a select resource for mark option button 1331m that may be selected by the user to access and create a mark for that recommended resource 1331 (e.g., selection of select resource for mark option button 1331m may be operative to cause the RASP to provide a mark defining interface region that may be similar to mark defining interface region 450 of FIG. 4, but where the resource identifier region of that mark defining interface region may be pre-populated with a proper resource identifier for recommended resource 1331). Each recommended resource of recommendation interface region 1330r may be determined in any suitable manner by the RASP, such as by recommending other resources that other users (e.g., other users similar to or in the same social network as the user of presentation 1300) accessed prior to or after the resource of a mark that survived the current search (e.g., resources that shared similar access flow paths with a resource of a mark that survived the current search).

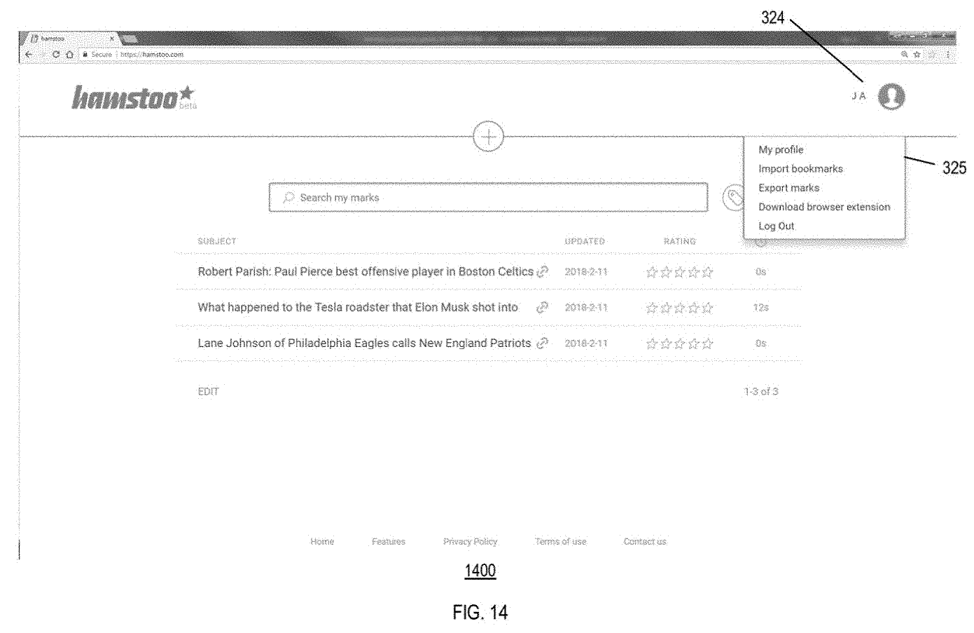

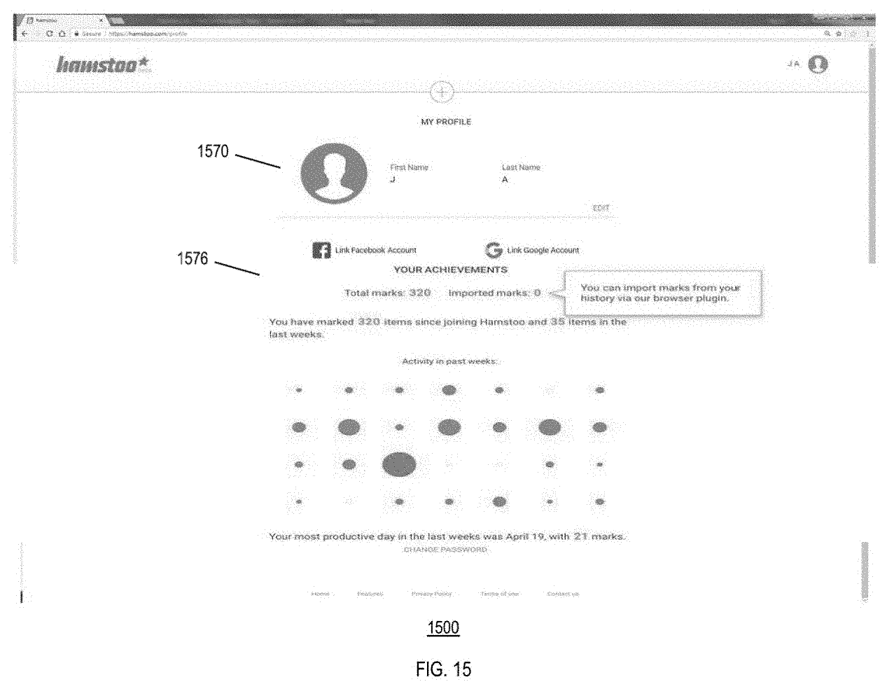

Various additional options may be made available to a user of the user RAS app besides those described with respect to presentations 300-1300. For example, as shown by presentation 1400 of FIG. 14, in response to user selection of user identification content 324 or any other suitable option, a feature pop-up box or other suitable feature interface 325 may be provided that may include a listing of various additional option available to the authenticated user of the user RSA app (e.g., user “JA”). As shown, for example, a first option of feature interface 325 may be a “My Profile” option that may allow the user to adjust certain settings of the user's profile, such as color scheme or any other suitable presentation characteristic options, log-in credential options (e.g., to change a password or associate another user identifier (e.g., telephone number or e-mail address) with the user's RASP account), and/or the like. As shown by presentation 1500 of FIG. 15, for example, selection of a “My Profile” option of feature interface 325 may result in a user being presented with a profile summary interface 1570 that may include details about the user's personal details that may be updated and/or options for the user to link its RASP account to an account the user may maintain with another service platform, such as the user's account on a social media network (e.g., Facebook™) for enabling detection of other users on the RASP that may be socially linked with the user or for any other suitable purpose. Additionally, as shown by FIG. 15, for example, selection of a “My Profile” option of feature interface 325 may result in a user being presented with a user history interface 1576 that may present information indicative of any suitable history of the user's activity on the RASP, including, but not limited to, an indication of the total number of marks defined for the user, the number of marks defined for the user over the last four (4) weeks, and/or a calendar-like interface graphically indicating the relative number of marks defined for the days over the last four (4) weeks including the ability for the user to select a particular day to gain more mark information for that selected day. Referring back to presentation 1400 of FIG. 14, another option of feature interface 325 may be an “Import Marks” option that may allow the user to import marks from any suitable file (e.g., an HTML file) and/or from another RASP user's account into the user's RASP account and/or from another service into the user's RASP account (e.g., to import basic bookmarks from any suitable web browser into the user's RASP account, whereby the RASP may then enable the user to add or otherwise edit mark data associated with each imported mark (e.g., user annotation data of the mark) and/or the RASP may automatically generate its own mark data to be associated with each imported mark (e.g., system metadata and/or resource content retrieval data of the mark)). Yet another option of feature interface 325 may be an “Export Marks” option that may allow the user to export marks from the user's RASP account into any suitable file, into another RASP user's account, and/or from the user's RASP account into another service (e.g., to export marks defined by the RASP into a collection of bookmarks for any suitable web browser). Yet another option of feature interface 325 may be a “Log Out” option that may allow the user to log out from the RASP.

Yet one other option of feature interface 325 may be a “Download Browser Extension” option that may enable the download (e.g., onto the user's RC subsystem 100d (e.g., from RAS subsystem 10 or from an extension store of a TP subsystem)) of a RAS browser extension (e.g., a plug-in) that may extend the functionality of a web browser that may be providing at least some functionality of the user RAS app to the user. Such a RAS extension may be configured to enable easier selection of an accessed resource for defining a mark. For example, rather than accessing a new to-be-marked web resource in a web browser tab other than web browser tab 320 and then copying and pasting the resource identifier (e.g., URL) for that accessed web resource from the other web browser tab into a resource identifier region of the user RSA app provided at web browser tab 320 (e.g., copying and pasting resource identifier 651 of web browser tab 720 of FIG. 7 into resource identifier region 451 of presentation 400 of FIG. 4), the web browser tab in which the user may be accessing the new to-be-marked web resource may have its functionality extended by the RAS browser extension, such that a more efficient and seamless user experience may be provided for enabling a resource to be marked.

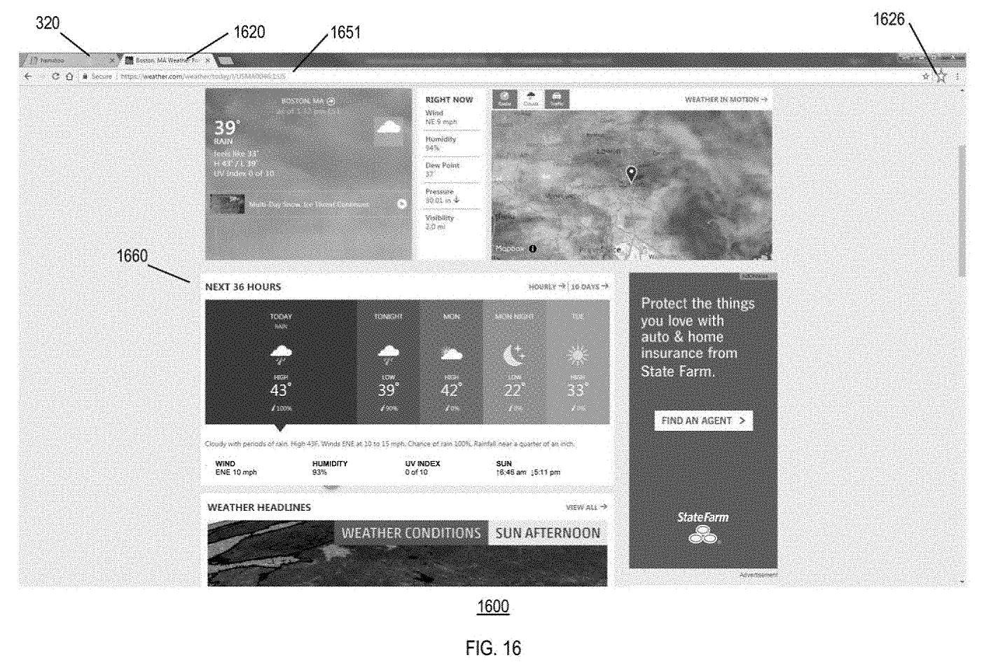

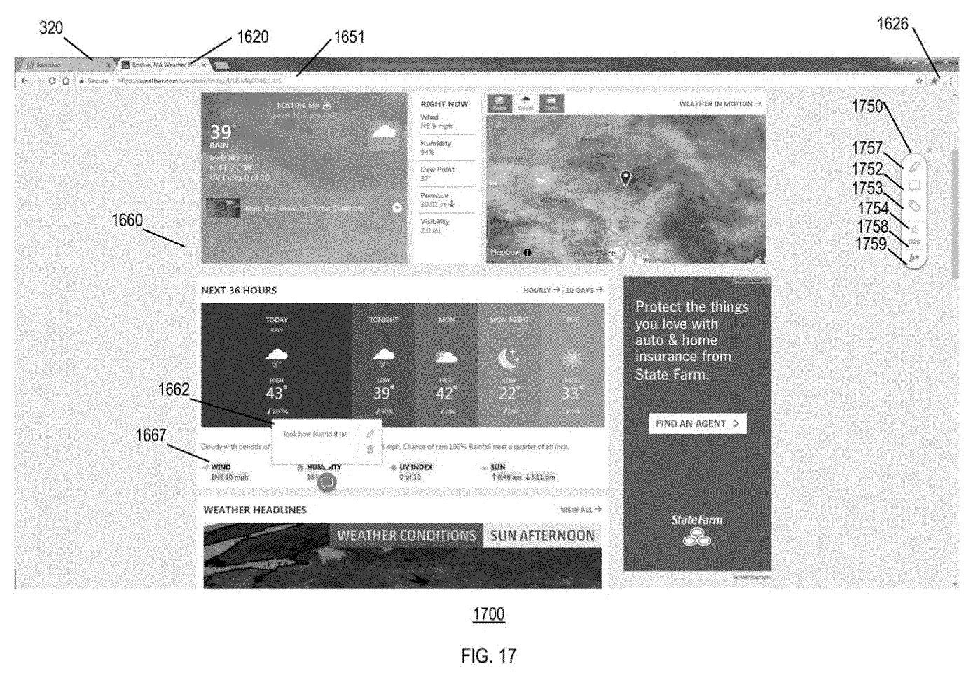

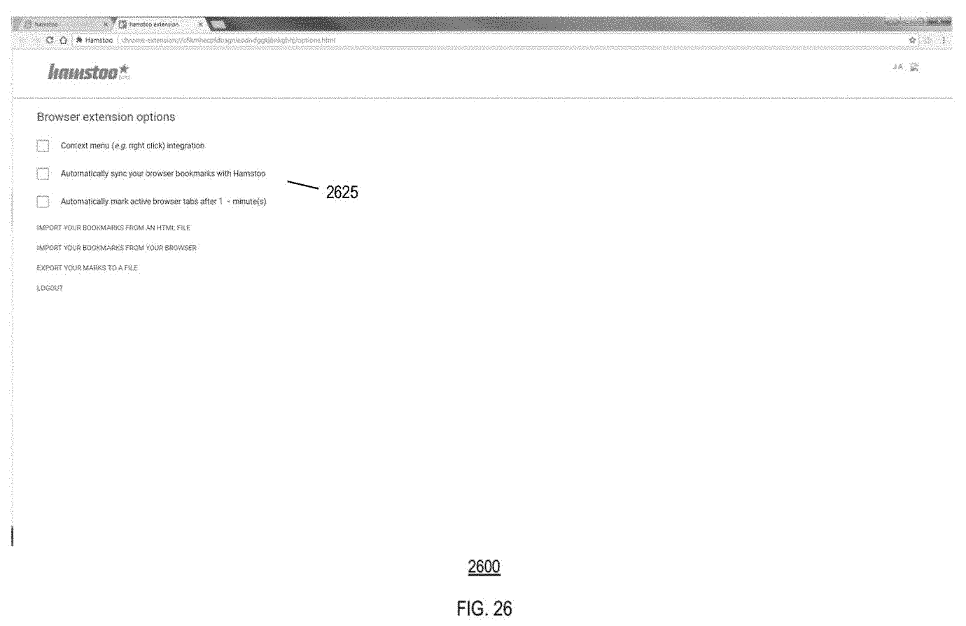

As shown by presentation 1600 of FIG. 16, for example, once an RAS browser extension has been properly loaded on the RP subsystem of the user, an RAS browser extension (RASBE) icon 1626 (e.g., an italicized star) may be provided by each web browser tab utilized by a user (e.g., at least while the extension is enabled and the user is logged-in to the RASP). RASBE icon 1626 of a particular web browser tab may be transitioned between a first state (e.g., an unselected empty state of presentation 1600 of FIG. 16) and a second state (e.g., a selected filled-in state of presentation 1700 of FIG. 17) to indicate whether or not the resource accessed by that web browser tab has been marked (e.g., whether or not a mark has been defined for the accessed resource of that tab). Presentation 1600 of FIG. 16 shows that a new web browser tab 1620 may be opened (e.g., adjacent web browser tab 320 of the user RSA app) that may be pointed (e.g., via any user web surfing path) to a URL resource identifier 1651 for presenting content 1660 of a particular web resource (e.g., as may be hosted by and provided from a particular RP subsystem (e.g., RP subsystem 100b) to RC subsystem 100d). Further, as shown by presentation 1600, RASBE icon 1626 of web browser tab 1620 may be in a first or unselected state, which may be operative to indicate to the user that the resource currently accessed by web browser tab 1620 has not been marked (e.g., no mark data has been obtained for defining a mark to be associated with the accessed resource). However, although presentation 1700 of FIG. 17 still shows that web browser tab 1620 is pointed to URL resource identifier 1651 for presenting content 1660 of the same particular web resource as that of FIG. 16, presentation 1700 also shows that RASBE icon 1626 of web browser tab 1620 has been transitioned from the first or unselected state to a second or selected state (e.g., as indicated by the solid filled-in configuration of RASBE icon 1626), which may be operative to indicate to the user that the resource currently accessed by web browser tab 1620 has been marked (e.g., mark data has been obtained for defining a mark to be associated with the accessed resource for the user's RASP account). A transition of RASBE icon 1626 of web browser tab 1620 from the first or unselected state to the second or selected state may be carried out in response to any suitable event. For example, in some embodiments, such a transition for defining a mark for the accessed resource may occur in response to a user actively selecting RASBE icon 1626 for transition (e.g., by clicking on the icon when the user wants the accessed resource to be marked). Alternatively or additionally, such a transition for defining a mark for the accessed resource may automatically occur in response to the resource having been accessed for a threshold period of time. For example, the RASP may be configured to automatically define a mark for any resource that has been accessed by a browser tab that then remains active for at least one minute, or for at least two minutes, or for at least one millisecond (e.g., automatically upon resource access), or for any other suitable amount of time. The RASP may enable a user to define such a threshold period of time and/or any other suitable conditions after which an accessed resource may be automatically marked. For example, as shown by presentation 2600 of FIG. 26, the RAS browser extension may be operative to provide a user with any suitable extension options of an option interface region 2625, which may include “automatically mark active browser tabs after 1 (or other user-defined number) minute(s)” and/or “automatically sync your browser bookmarks with Hamstoo” and/or enable “context menu (e.g., right click) integration” and/or “import your bookmarks from an HTML file” and/or “import your bookmarks you're your browser” and/or “export your marks to a file” and/or “logout” of the extension browser and/or of the RASP and/or any other suitable options. Therefore, the RAS browser extension may be configured to define automatically a mark for every resource accessed by the user's web browser whether or not the user actively engages with the RASBE icon or actively defines any user annotation data while accessing the resource. This may enable a user to browse the web or experience any other suitable resources with confidence that each accessed resource may be automatically marked (e.g., at operation 2804 and operation 2806) with appropriate resource content retrieval data and/or with appropriate system metadata that may then be later used (e.g., at operation 2808) in efficiently and/or effectively enabling the user to recall one or more particular marked resources.

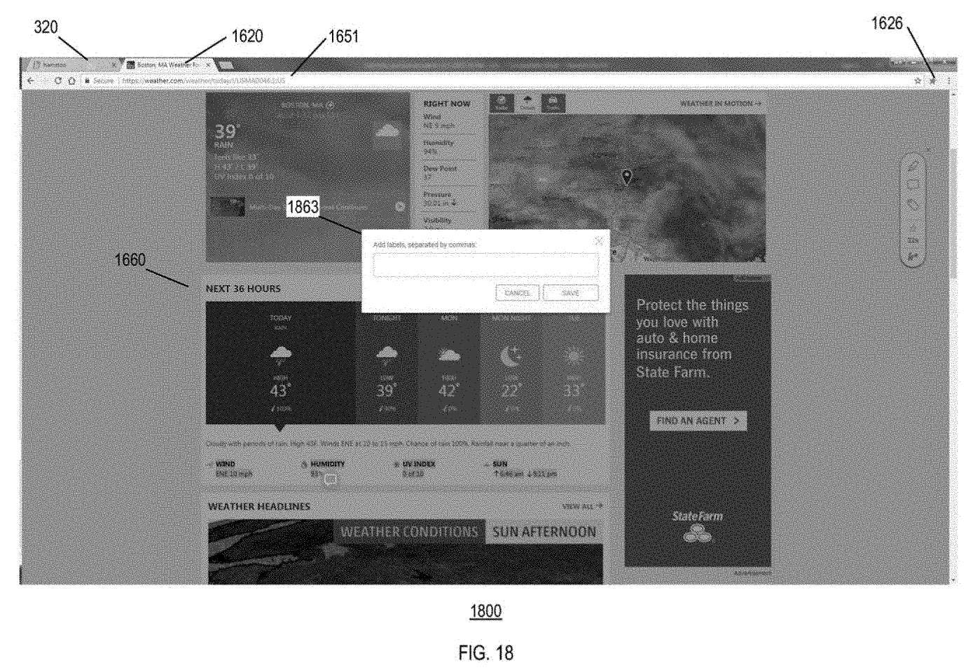

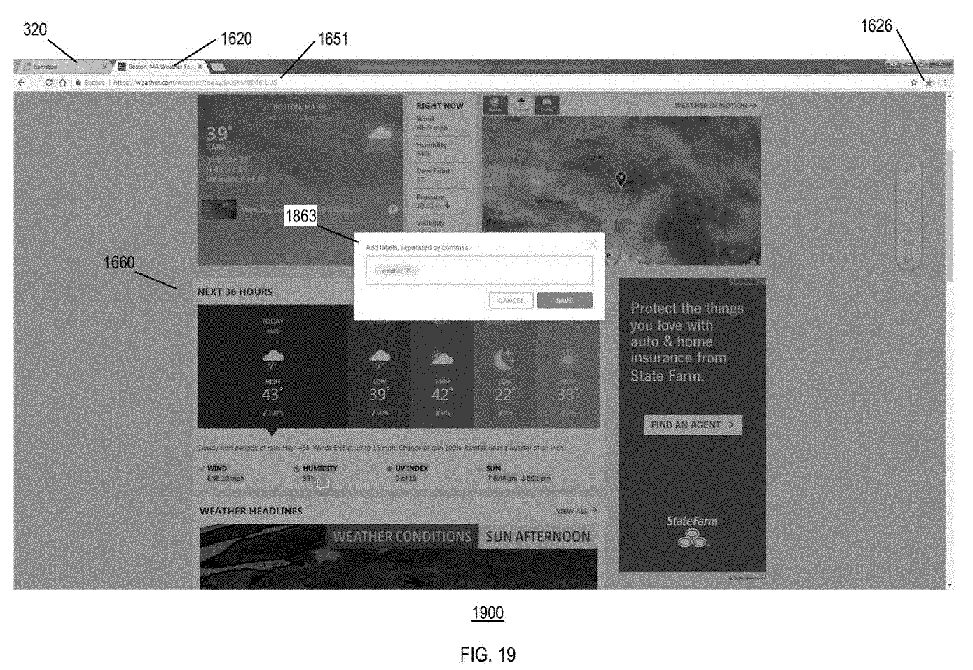

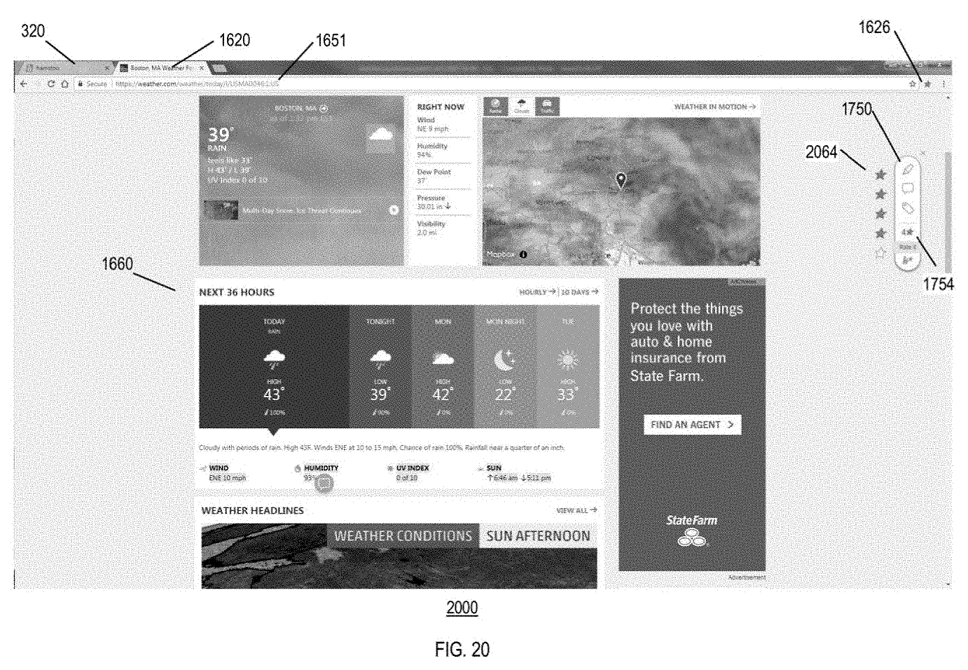

When RASBE icon 1626 is selected or activated or otherwise enabled for marking the resource accessed by web browser tab 1620, as shown by presentation 1700 of FIG. 17, not only may a mark be initially defined for the accessed resource using any suitable mark data that may be automatically detected or otherwise generated by the RASP (e.g., any suitable resource content retrieval data and/or any system metadata associated with the resource accessing), but also a user annotation toolbar 1750 may be provided (e.g., as a pop-up window or overlay on or adjacent content 1660), where user annotation toolbar 1750 may be operative to enable a user to initiate the creation of any suitable user annotation data for further defining the mark data of the mark for the accessed resource. As shown, user annotation toolbar 1750 may include a content enhancement icon 1757 that may be selected by the user for enhancing certain text or other enhanceable elements of content 1660 (e.g., an enhanced text portion 1667 of content 1660), where the enhanced content and the type of enhancement may be used to define particular user annotation data for the mark data of the defined mark. The RASP may store, as a portion of the mark data of a defined mark, resource content retrieval data that may provide at least a portion of the content of the accessed resource (e.g., as described with respect to content 860 and 960), such that any enhanced content annotation data (e.g., enhanced text portion 1667 of content 1660) may be tied to the originally accessed resource content (e.g., as provided by the resource content retrieval data) throughout the life of the mark and/or the life of that enhanced content annotation data. The enhancement of enhanced content of such user annotation data may be any suitable type or one of many available and selectable enhancement types (e.g., highlight enhancement, underline enhancement, italicize enhancement, bold enhancement, strike through enhancement, and/or the like). Additionally or alternatively, as shown, user annotation toolbar 1750 may include a comment icon 1752 that may be selected by the user for defining any suitable comments to be associated with the resource (e.g., with any particular portion of the resource or with the resource generally). Such comments may be any suitable comments (e.g., textual, audible, graphical, etc.) that the user may convey (e.g., for indicating any suitable user reaction to the resource). For example, such comments may include a user's thoughts on the content of the resource, or the user's reasoning for defining a mark for the resource, and/or any other suitable comments. As one example, a comment 1662 (e.g., “look how humid it is!”) may be provided at a particular location with respect to content 1660 (e.g., just adjacent a portion of enhanced text portion 1667), where the content of the comment and the location of the comment may be used to define particular user annotation data for the mark. Additionally or alternatively, as shown, user annotation toolbar 1750 may include a tag or label icon 1753 that may be selected by the user for defining or selecting any suitable labels to be associated with the resource. Such labels may be any suitable labels (e.g., new or pre-defined) that the user may wish to associate with the resource being marked (e.g., for indicating any suitable user reaction to the resource). As one example, as shown by presentation 1800 of FIG. 18, in response to selecting label icon 1753 of user annotation toolbar 1750, a label interface region 1863 may be provided (e.g., as a pop-up window or overlay on or adjacent content 1660), where label interface region 1863 may be operative to enable a user to create a new label or select an existing label to associate with the resource mark. For example, as shown by presentation 1900 of FIG. 19, a label “weather” may be provided in label interface region 1863 and saved using a “save” radio button of label interface region 1863, where the saved label content of label interface region 1863 may be used to define particular user annotation data for the mark. Additionally or alternatively, as shown, user annotation toolbar 1750 may include a rating icon 1754 that may be selected by the user for defining or selecting any suitable rating or ranking to be associated with the resource. As one example, as shown by presentation 2000 of FIG. 20, in response to selecting rating icon 1754 of user annotation toolbar 1750, a rating interface region 2064 may be provided (e.g., as a pop-up window or overlay on or adjacent content 1660), where rating interface region 2064 may be operative to enable a user to select any suitable rating or ranking for use in at least partially defining user annotation data for the mark. Such a rating may be any suitable format (e.g., 1-5 stars, different emojis, a sliding scale bar, etc.) that the user may wish to associate with the resource being marked (e.g., for indicating any suitable user reaction to the resource).

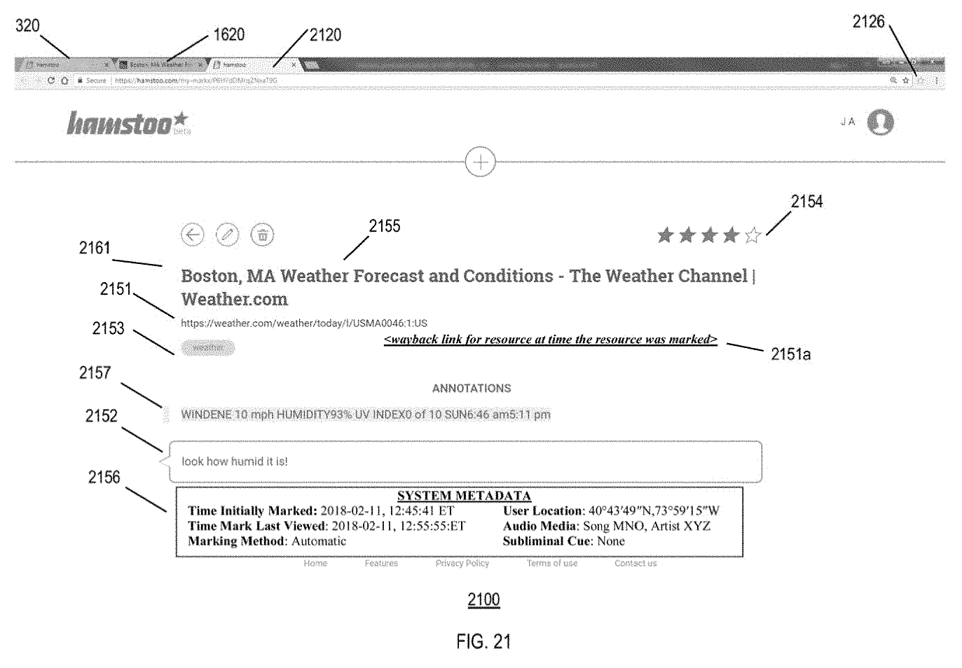

Any new user interaction with toolbar 1750 may result in mark data of the mark being automatically updated (e.g., with new or adjusted user annotation data). Additionally or alternatively, as shown, user annotation toolbar 1750 may include a timer icon 1758 that may be used by the RASP to identify the amount of time for which content 1660 of the resource has been accessed by web browser tab 1620 or any other suitable amount of time (e.g., the total amount of time for which tab 1620 has been active, or open but not necessarily active (e.g., not necessarily the tab of user interest), and/or the like), where such time may be used to define at least a portion of the mark data (e.g., a portion of the system metadata of the mark data of the mark). Additionally or alternatively, as shown, user annotation toolbar 1750 may include a mark detail icon 1759 that may be selected by the user at any time for accessing a detailed view of the defined mark. For example, as shown by presentation 2100 of FIG. 21, an illustrative detailed mark interface 2161 may be presented (e.g., in a new web browser tab 2120 (as shown) or in legacy user RAS app tab 320) in response to a user selecting mark detail icon 1759 of toolbar 1750. As shown, detailed mark interface 2161 may include a subject or title 2155 for the mark (e.g., a title of the underlying resource, as may be derived from the content of the resource itself, the resource indictor, any suitable user provided user annotation data, and/or any other suitable data). Detailed mark interface 2161 may include a resource identifier 2151 for the resource of the mark (e.g., resource identifier 1651 of web browser tab 1620 of presentation 1700) and/or a time locked resource identifier or archived content link 2151a that may be similar to resource identifier 1651 and 2151 but for the resource at a particular moment in time (e.g., the time at which the resource was initially marked (e.g., the time of operation 2802 (e.g., the time at which RASBE icon 2126 was selected at presentation 1700) (e.g., a link similar to those provided by the Way Back Machine by the Internet Archive)), such that link 2151a may be used to re-access the same resource content (e.g., content 1660) at the time of operation 2808 as was accessed at the time of operation 2802 even if link 1651 and/or link 2151 does not access the same resource content (e.g., if the RP subsystem has updated the resource at link 1651 since the time it was accessed at operation 2802). Identifier 2151 and/or identifier 2151a may be obtained and stored by the RASP as a type of resource content retrieval data for the defined mark.

Detailed mark interface 2161 may include one or more comments 2152 for the resource of the mark (e.g., comment(s) 1662 of presentation 1700). Detailed mark interface 2161 may include one or more labels 2153 for the resource of the mark (e.g., the label(s) provided into label interface region 1863). Detailed mark interface 2161 may include one or more ratings 2154 for the resource of the mark (e.g., the rating provided into rating interface region 2064). Detailed mark interface 2161 may include one or more content enhancements 2157 for the resource of the mark (e.g., the enhanced text portion 1667 of content 1660). Comment data 2152, label data 2153, rating data 2154, and content enhancement data 2157 may be obtained and stored by the RASP (e.g., based on user input commands when interacting with toolbar 1750) as various types of user annotation data for the defined mark. In addition to or as an alternative to any suitable user annotation data (e.g., comments 2152, labels 2153, ratings 2154, content enhancements 2157, etc.), the defined mark detailed by detailed mark interface 2161 may include any suitable system metadata 2156 that may be automatically detected by the RASP (e.g., by RC subsystem 100d or otherwise), including, but not limited to, a time at which the resource was initially marked (e.g., at which the mark was initially defined (e.g., the time at which RASBE icon 2126 was selected at presentation 1700)), the time at which the mark (and/or the associated resource's content) was last viewed by the user, the method by which the resource was identified for marking (e.g., manually by the user or automatically or otherwise (e.g., after meeting a time threshold of accessibility)), an aggregate amount of time during which the resource's content was accessed by the user (e.g., an aggregate amount of time during which tab 1620 with content 1660 was active and/or at all open), a location of the user (e.g., a location of RC subsystem 100d (e.g., as detected by a GPS sensor component 115)) when the mark was initially defined, identification of any audio media being played back by the user when the mark was initially defined (e.g., audio being played back (e.g., by a music app) independently of the accessing of the marked resource), any subliminal cues associated with the marked resource, a flow path associated with the marked resource (e.g., another resource with a link that was used to access the resource for defining the mark and/or another resource that was accessed by a link in the marked resource), and/or the like. Therefore, the RAS browser extension may be configured to track the amount of time each resource is accessed in various states (e.g., the amount of time presented in an open and actively accessible web browser (e.g., like content 1660 of tab 1620 of presentation 2000) and/or the amount of time each resource is presented in an open web browser that is not being actively accessed (e.g., like content 1660 of tab 1620 of presentation 2100), and/or any other state of access), and such time may be used to define any suitable system metadata for the resource's mark. Presentation 2100 may be operative to enable a user to edit any suitable characteristics of the defined mark, such as by adding any new user annotation data, editing or deleting any existing user annotation data, or deleting the entire mark.

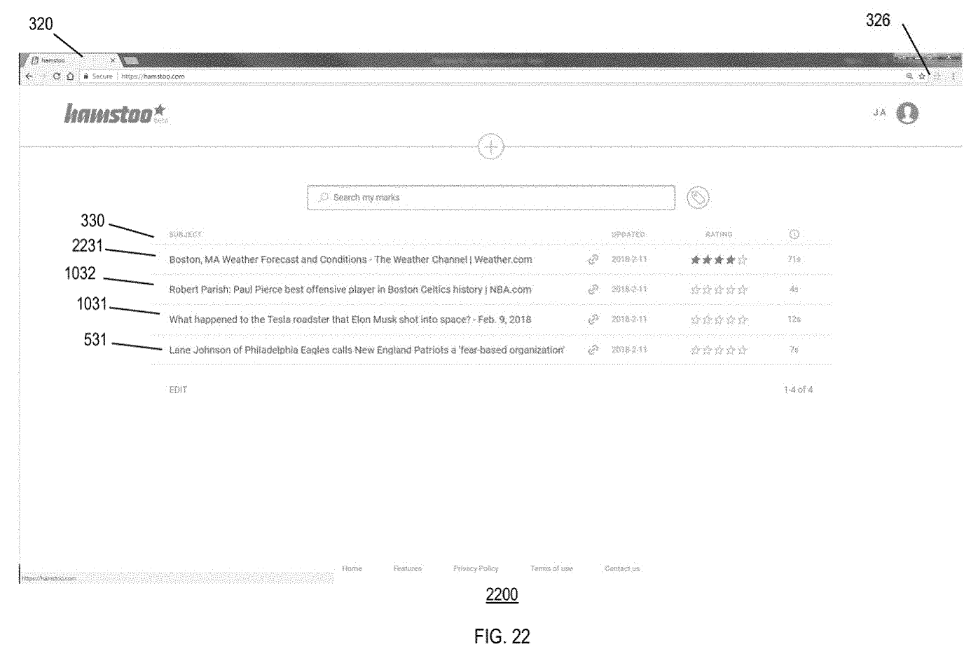

Operations 2802-2806 of process 2800 of FIG. 28 may be repeated for accessing different resources and defining a mark for each accessed resource using the RAS browser extension (e.g., as described with respect to presentations 1600-2100 of FIGS. 16-21). After each new mark is defined, as shown by presentation 2200 of FIG. 22, mark listing interface region 330 may be updated to include not only mark listings 531, 1031, and 1032, but also additional mark listing 2231 that may be indicative of the mark detailed by detailed mark interface 2161. Each one of mark listings 531, 1031, 1032, and 2231 may be selected for opening a new detailed view of the mark and/or interacted with in any other suitable manner. The mark listings of listing interface region 330 may be selectively ordered in any suitable manner (e.g., through user selection or otherwise), such as alphabetically by subject, chronologically by the date at which the marks of the listings were defined, by rating level, by duration of time in which the marks were defined, and/or the like. Therefore, listing interface region 330 may provide a snap shot of an overall history of the user's experiences with various accessed resources.

Certain mark data used to define a mark for an accessed resource may later be used by a user in recalling that resource. For example, as described with respect to presentations 1000-1300, certain search requests may include labels or terms that may then be identified in the mark data of one or more defined marks for enabling the search to reveal the appropriate marks for enabling user recall of their underlying resource content. Various types of data that may be used to define mark data for a mark may enable various types of recall to be utilized by a user to efficiently and effectively retrieve a previously accessed resource and its associated mark data. As just one example, if several weeks after a user read an article online (e.g., web resource content 760 associated with the mark data of the defined mark detailed by detailed mark interface 661 of presentation 800), the user may want to re-read a portion of the article but may not exactly remember how to re-access the article via normal channels (e.g., by a simple internet search engine). Instead, the user may only remember certain details about the article of interest, such as the facts that the user previously accessed the article between 3 and 5 weeks ago while located in New York City and while song ABC by artist XYZ was being played back by the user's RC subsystem. In such a scenario, the RASP may be effectively utilized by the user to define a particular search using those facts (e.g., using any suitable mark searching interface, such as mark searching interface region 340) and the RASP may be configured to immediately recall the previously defined and stored mark associated with the resource content of interest (e.g., web resource content 760 associated with the mark data of the defined mark detailed by detailed mark interface 661 of presentation 800, due to the fact that system metadata 656 includes data indicative of the date at which the mark was previously accessed, data indicative of the location of the user during that access, and data indicative of audio media that was being played back during that access). As mentioned, any suitable types of system metadata may be automatically defined by the RASP for populating the mark data of a mark for a resource including, but not limited to a time at which the resource was initially marked (e.g., at which the mark was initially defined), the time at which the mark (and/or the associated resource's content) was last viewed by the user, the method by which the resource was identified for marking (e.g., manually by the user (e.g., at presentation 400) or automatically or otherwise), an aggregate amount of time during which the resource's content was accessed by the user, a location of the user (e.g., a location of RC subsystem 100d (e.g., as detected by a GPS sensor component 115)) when the mark was initially defined, identification of any audio media being played back by the user when the mark was initially defined (e.g., audio being played back (e.g., by a music app) independently of the accessing of the marked resource), any subliminal cues associated with the marked resource, a flow path associated with the marked resource (e.g., another resource with a link that was used to access the resource for defining the mark and/or another resource that was accessed by a link in the marked resource), and/or the like.

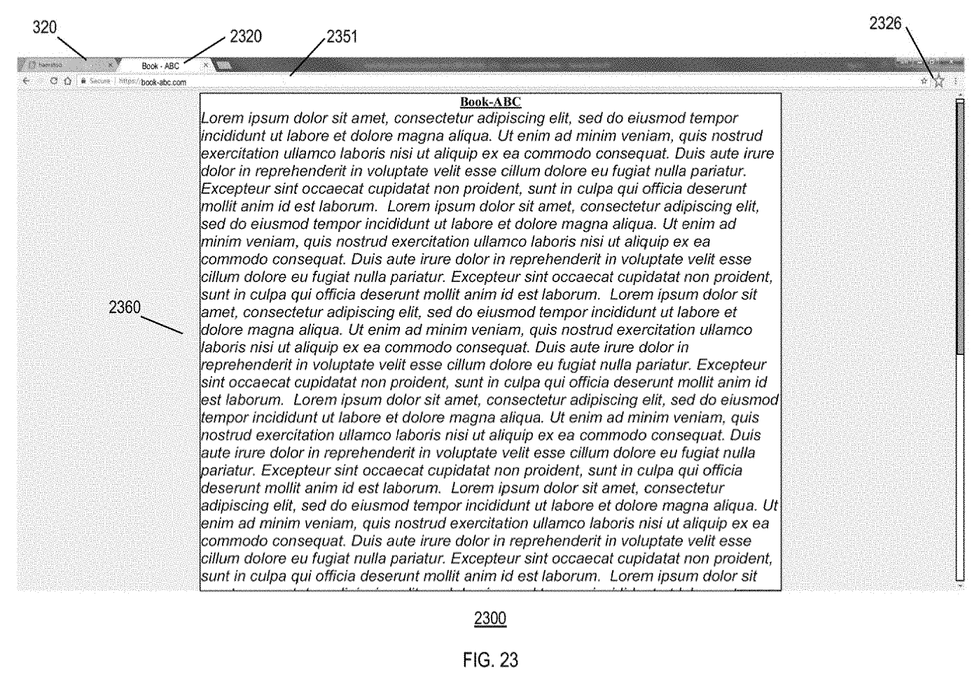

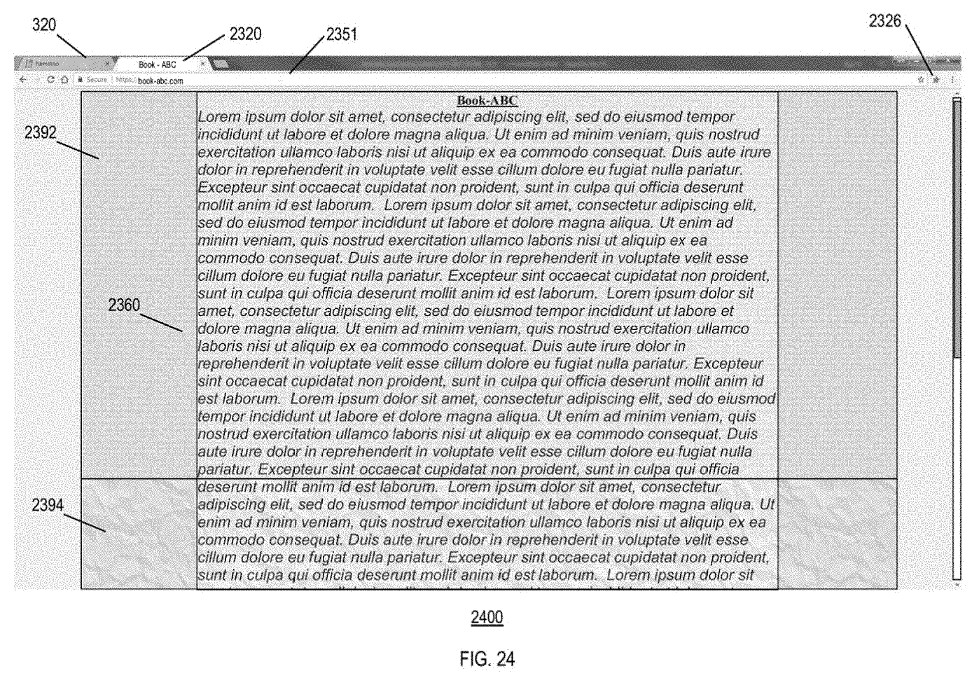

A particular type of system metadata may be subliminal cue data, which may be data indicative of one or more specific presentation characteristics of one or more subliminal cues that may have been implemented to define how the resource content may have been presented to the user when the resource was accessed (e.g., at operation 2802). A subliminal cue may be utilized for the purpose of better enabling a user to recall the resource content (e.g., by enabling the user to be more likely to execute an effective search for the previously accessed resource content using the subliminal cue data (e.g., at operation 2808)). Subliminal cues may be implemented by the RASP and not by the resource content creator and/or the resource content provider (e.g., RP subsystem 100a), as the subliminal cue may not be related to the content itself but may be provided only to trigger memory cues in the user's brain for later recall. For example, presentation 2300 of FIG. 23 shows that a new web browser tab 2320 may be opened (e.g., adjacent web browser tab 320 of the user RSA app) that may be pointed (e.g., via any user web surfing path) to a URL resource identifier 2351 for presenting content 2360 of a particular web resource (e.g., a “Book ABC” of textual content, as may be hosted by and provided from a particular RP subsystem (e.g., RP subsystem 100b) to RC subsystem 100d). Further, as shown by presentation 2300, RASBE icon 2326 of web browser tab 2320 may be in a first or unselected state, which may be operative to indicate to the user that the resource currently accessed by web browser tab 2320 has not been marked (e.g., no mark data has been obtained for defining a mark to be associated with the accessed resource). However, although presentation 2400 of FIG. 24 still shows that web browser tab 2320 is pointed to URL resource identifier 2351 for presenting content 2360 of the same particular web resource as that of FIG. 23, presentation 2400 also shows that RASBE icon 2326 of web browser tab 2320 has been transitioned from the first or unselected state to a second or selected state (e.g., as indicated by the solid filled-in configuration of RASBE icon 2326), which may be operative to indicate to the user that the resource currently accessed by web browser tab 2320 has been marked (e.g., mark data has been obtained for defining a mark to be associated with the accessed resource for the user's RASP account). When RASBE icon 2326 is selected or activated or otherwise enabled for marking the resource accessed by web browser tab 2320, as shown by presentation 2400 of FIG. 24, not only may a mark be initially defined for the accessed resource using any suitable mark data that may be automatically detected or otherwise generated by the RASP (e.g., any suitable resource content retrieval data and/or any system metadata associated with the resource accessing), but also one or more subliminal cues may be presented to the user along with the marked resource being accessed.

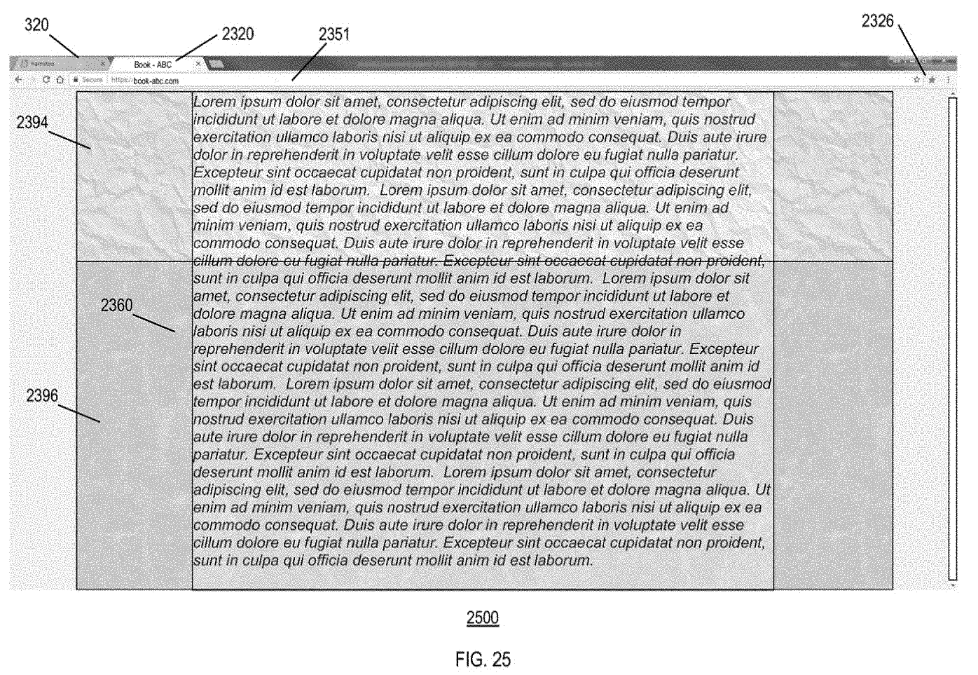

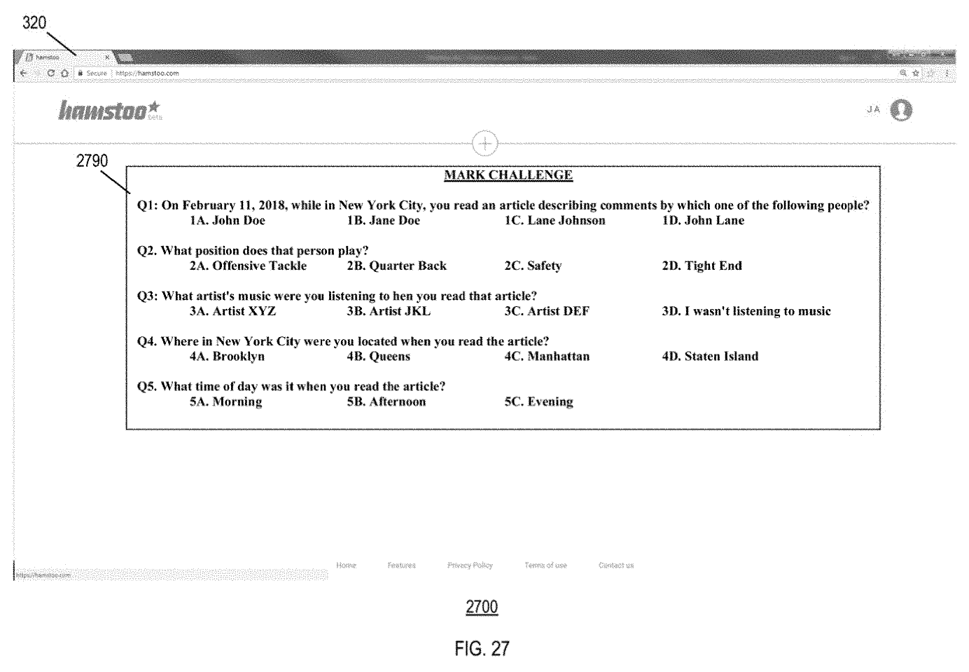

For example, as also shown by presentations 2400 and 2500 of FIGS. 24 and 25 that may present different halves of resource content 2360 when scrolled on a user interface of the user RAS app, one or more visual cues, such as visual subliminal cues 2392, 2394, and 2396, may be generated and presented to the user along with resource content 2360 when marked in order to aid the user's ability to later recall the resource content and/or other features of the mark. Subliminal cue 2392 may be provided as a background layer or a semi-transparent layer on the same portion of presentation 2400 as a first portion of resource content 2360 (e.g., a top third of resource content 2360), subliminal cue 2394 may be provided as a background layer or a semi-transparent layer on the same portion of presentations 2400 and 2500 as a second portion of resource content 2360 (e.g., a middle third of resource content 2360), and subliminal cue 2396 may be provided as a background layer or a semi-transparent layer on the same portion of presentation 2500 as a third portion of resource content 2360 (e.g., a bottom third of resource content 2360). Different ones of subliminal cues 2392, 2394, and 2396 may differ from one another in any suitable way, such as by pattern, color, filter, tint, brightness, and/or the like. Other types of subliminal cues may be provided in addition to or as an alternative to color-based cues, including, but not limited to, pattern-based cues (e.g., a virtual corner of a page or presented portion of content may be folded over (e.g., as may be common when a physical paper book may be read) in different corners for different pages/portions of the content), tactile-based cues (e.g., the user's RC subsystem 100d may provide different types of haptic feedback when different content is presented), olfactory-based (e.g., the user's RC subsystem 100d may provide different types of smells or aromas when different content is presented), sound-based cues (e.g., the user's RC subsystem 100d may provide different sounds (e.g., sound effects or otherwise) when different content is presented), and/or the like. Such subliminal cues may be presented for no current purpose and not to enhance the user's experience of the resource content when being accessed, but with the specific intent of making the user's experience more memorable during a recall attempt, as certain subliminal cues may be used by the user's subconscious memory to assist in internal mind recall. Any subliminal data indicative of any cue(s) used during presentation of the resource content may be stored as a portion of system metadata defining the mark data of the resource's mark for enabling effective use of such subconscious memory internal mind recall. For example, if subliminal cue 2392 is red and subliminal cue 2394 is blue, and subliminal cue 2396 is green, and a user searching for particular content indicates that the content sought was provided with a green background, then only the final third of resource content 2360 may be searched and/or potentially presented to a user in response to that search. Mark data of a marked resource previously accessed by a user may not only be helpful when a user is attempting to recall the mark (e.g., via an efficient and effective search process), but certain mark data may be used by the RASP to generate certain quizzes or other games that may help keep a user's mind sharp and improve future recall. For example, a certain type of user annotation data of a mark may be used for a user to indicate whether or not that mark should be used to generate one or more challenges for the user at a future time. For any mark indicated by the user as of interest for a challenge, or for any mark at all, the RASP may analyze the mark data and generate one or more challenges. For example, with respect to the mark data of detailed mark interface 661 of presentation 800, the RASP may be configured to generate automatically any suitable challenge for the user to respond to, such as the questions indicated by challenge interface 2790 of presentation 2700 of FIG. 27, each of which may be automatically generated by any suitable computational power provided to the RASP and/or by other users of the RASP.

Although the examples of presentations 300-2700 may be described with respect to web resource content (e.g., web pages and/or e-book content with textual content that may or may not include images, video, advertisements, widgets of various types of functionality, and/or the like), it is to be understood that any resource of any suitable type with any suitable content may be accessed and used to define a mark according to process 2800 and/or any other process described herein. For example, a resource may be a podcast whose content is primarily audio data, wherein any suitable processing may be carried out to generate any suitable type of mark data. For example, speech to text translation and/or music recognition processing may be carried out on some or all of the audio content (e.g., locally on RC subsystem 100d, by the provider of the content (e.g., by an RP subsystem), by RAS subsystem 10, and/or by any suitable TP subsystem), such that such processing may provide data that may be used to define any suitable mark data of the mark defined for the resource (e.g., speech to text data may be used to define at least a portion of the mark's resource content retrieval data). Additionally or alternatively, some or all presentation of data by the RASP (e.g., by the user RAS app) to the user may be purely audible and not visual, and/or user interaction with the RASP may be voice controlled (e.g., via user vocal commands (e.g., for defining a search for resource recall) rather than via any graphical user interface). In some embodiments, for audio content of an accessed resource, the RASP may be operative to detect the range of the tones of the audio content and then, if the detected original range of the tones do not meet a certain threshold width, the RASP may automatically increase or otherwise widen the range of the audio content's tones before presenting that content to the user. This may enable the audio content to be more memorable to the user as it has been discovered that verbal information is more readily remembered when spoken in a wide vocal range than when spoken in a limited vocal range. Therefore, the RASP may be operative to artificially accentuate the low and/or the high tones of audio content of a resource when presenting that audio content to a user such that the audio content may be more memorable to the user.

Use of the RASP by an end user's RC subsystem may be done while the RC subsystem is communicatively coupled to one or more other subsystems of system 1 (e.g., when the RC subsystem is “online” and may share data with RAS subsystem 10 and/or any suitable RP subsystem and/or any suitable TP subsystem). Alternatively, the RASP may be used by an end user's RC subsystem when that RC subsystem is not communicatively coupled to any other subsystem of system 1 (e.g., when the RC subsystem is “offline” and may not communicate data with RAS subsystem 10 and/or any suitable RP subsystem and/or any suitable TP subsystem). In such embodiments, any resource accessed by the RC subsystem may be local to the RC subsystem and/or any mark data search or otherwise used by the RC subsystem may be locally stored on the RC subsystem. In some embodiments, before going offline, an RC subsystem may download from RAS subsystem 10 all user data for the RASP that may be managed by RAS subsystem 10 (e.g., all mark data), such that the RASP may be effectively used by a user of the RC subsystem when offline. Similarly, when going back online, the RC subsystem may upload any suitable (e.g., any new) RASP data that may have been generated on board the RC subsystem while offline.

Certain resource content may be captured or otherwise defined by a user of an RC subsystem and then shared with the RASP. For example, a user may be reading a physical newspaper and may discover some content of interest, in which case the user may photograph with a camera accessible to the user's RC subsystem any suitable portion of the physical newspaper (e.g., an article of interest or a portion thereof) and the RASP (e.g., a user RAS app available to the RC subsystem) may store that photograph as resource content retrieval data for a mark being defined for that newspaper article. In some embodiments, the user may dictate (e.g., via a microphone of the RC subsystem) certain portions of the newspaper article, which the RASP may be configured to translate to text and store as any suitable user annotation data of the mark data (e.g., comment data and/or highlight data and/or the like).

It is understood that the operations shown in process 2800 of FIG. 28 are merely illustrative and that existing operations may be modified or omitted, additional operations may be added, and the order of certain operations may be altered. Therefore, the RASP is significantly more than just a conventional web browser bookmark scheme. Instead, the RASP enables a user to mark any type of resource with any type of content, not just conventional web browser content, for later recall. Further, the RASP enables a user to annotate the marked resource content in various suitable ways, including to highlight and take notes directly on top of or otherwise positionally associated with the original content of the resource (e.g., as may be captured and stored by the RASP as a portion of the mark (e.g., as any suitable resource content retrieval data), The RASP may be configured to apply machine learning to a user's past resource content experiences to suggest other resource content that the user might have missed. The RASP may be configured to curate high quality resource recommendations based on data from other well understood users of the RASP community. The RASP may enable the user to experience augmented virtuality by providing the user with an intimate relationship with available resource content. No need to jump through any copy-and-pasting hoops, and certainly no need to waste paper. Instead, the RASP enables a user to interact with the web and other types of resources directly at the content source, and all user interactions may be saved where the user can search and navigate them later. While the internet may be great at storing knowledge and “facts,” it has conventionally been ineffective when it comes to storing a user's unique, personal memories and experiences, let alone effectively and efficiently search them for recall. The RASP addresses these previous shortcomings by providing augmented intelligence (e.g., the other AI) that is actually useful to all members of the RASP community. The RAS extension may enable a user to interact with the web directly at the content source, easily mark web pages by clicking a user-friendly RASBE icon in a web browser toolbar such that they may be saved to the user's account where they can be searched and navigated later. The RASP may enable a user to annotate the web through marking up web pages with highlights/notes or jotting down the user's thoughts or reactions or otherwise in the margins or specific areas of the content and will be stored to the user's account. The RAS extension may also, optionally, have an automark feature enabled such that the RASP may automatically (e.g., automagically) mark each site page or resource visited by the user (e.g., immediately, or after a minute or two). The user never has to worry that it won't be able to find what it accessed last week or last year or ever. All RASP content for a user may be downloaded and used offline at any time, including user annotation data, resource content retrieval data, and/or system metadata defining any user mark.

### Further Description of FIGS. 1-28

One, some, or all of the processes described with respect to FIGS. 1-28 may each be implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., memory 13 and/or data structure 19 of FIG. 1 and/or memory 113 and/or data structure 119 of FIG. 2). In other embodiments, the computer-readable medium may be a transitory computer-readable medium. In such embodiments, the transitory computer-readable medium can be distributed over network-coupled computer systems so that the computer-readable code may be stored and executed in a distributed fashion. For example, such a transitory computer-readable medium may be communicated from a RAS subsystem 10 to a subsystem 100, from a subsystem 100 to RAS subsystem 10, and/or from one subsystem 100 to another subsystem 100 using any suitable communications protocol (e.g., the computer-readable medium may be communicated to a subsystem 100 via communications component 14/114 (e.g., as at least a portion of a data structure 119)). Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is to be understood that any, each, or at least one module or component or subsystem of the disclosure may be provided as a software construct, firmware construct, one or more hardware components, or a combination thereof. For example, any, each, or at least one module or component or subsystem of system 1 may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules and components and subsystems of system 1 are only illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

It is to be understood that any user RAS app may be configured to provide any suitable presentations of information to the user, which may include only visual elements, only audible elements, only haptic elements, visual and audible and haptic elements, and/or another combination. Graphical user interface presentations may include any suitable graphical user interface elements, including, but not limited to, windows, dialog boxes, scrollbars, menu bars, tabs, ribbons, menus, buttons, text boxes, checkboxes, combo boxes, drop-down lists, list boxes, radio buttons, sliders, spinners, grids, labels, progress indicators, icons, tooltips, pop-up boxes, any other suitable widgets, and/or the like, that may be used to obtain input from and/or provide output to a user. For example, such widgets may be used via a widget toolkit, such as Microsoft Foundation Classes (MFC), Apple Cocoa Touch, Java Swing, GTK+, Qt, Yahoo! User Interface Library (YUI), and/or the like. In another implementation, such user interface elements may include sounds (e.g., event notification sounds stored in MP3 file format), animations, vibrations, and/or the like that may be used to inform the user regarding occurrence of various events. For example, the operating system subcomponent may include a user interface such as Windows Aero, Mac OS X Aqua, GNOME Shell, KDE Plasma Workspaces (e.g., Plasma Desktop, Plasma Netbook, Plasma Contour, Plasma Mobile), and/or the like.

A neural network or neuronal network or artificial neural network or any suitable artificial intelligence, machine learning, and or computer algorithm may be hardware-based, software-based, or any combination thereof, such as any suitable model (e.g., a computational model), which, in some embodiments, may include one or more sets or matrices of weights (e.g., adaptive weights, which may be numerical parameters that may be tuned by one or more learning algorithms or training methods or other suitable processes) and/or may be capable of approximating one or more functions (e.g., non-linear functions or transfer functions) of its inputs (e.g., to predict or estimate certain outcomes based on any suitable input data). The weights may be connection strengths between neurons of the network, which may be activated during training and/or prediction. A neural network may generally be a system of interconnected neurons that can compute values from inputs and/or that may be capable of machine learning and/or pattern recognition (e.g., due to an adaptive nature). A neural network may use any suitable machine learning techniques to optimize a training process. A neural network may be used to estimate or approximate functions that can depend on a large number of inputs and that may be generally unknown. A neural network may generally be a system of interconnected “neurons” that may exchange messages between each other, where the connections may have numeric weights (e.g., initially configured with initial weight values) that can be tuned based on experience, making the neural network adaptive to inputs and capable of learning (e.g., learning pattern recognition). A suitable optimization or training process may be operative to modify a set of initially configured weights assigned to the output of one, some, or all neurons from the input(s) and/or hidden layer(s). A non-linear transfer function may be used to couple any two portions of any two layers of neurons, including an input layer, one or more hidden layers, and an output (e.g., an input to a hidden layer, a hidden layer to an output, etc.).

Different input neurons of a neural network may be associated with respective different types of data categories and may be activated by category data of a respective mark, and/or the like. The weight assigned to the output of each neuron may be initially configured using any suitable determinations that may be made by RAS subsystem 10 based on the data available to RAS subsystem 10 or otherwise. Any suitable training methods or algorithms (e.g., learning algorithms) may be used to train a neural network of any functional engine of the RASP, including, but not limited to, Back Propagation, Resilient Propagation, Genetic Algorithms, Simulated Annealing, Levenberg, Nelder-Meade, and/or the like. Such training methods may be used individually and/or in different combinations to get the best performance from a neural network.

While there have been described systems, methods, and computer-readable media for a resource accessibility service, it is to be understood that many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Therefore, those skilled in the art will appreciate that the invention can be practiced by other than the described embodiments, which are presented for purposes of illustration rather than of limitation.

What is claimed is:

1. A method for operating a computer comprising:
accessing, by the computer, a resource;
defining a mark for the accessed resource, wherein the defined mark comprises mark data that comprises:
resource content retrieval data that is operative to provide at least a portion of the content of the accessed resource; and
system metadata associated with the accessing;
storing the defined mark; and
recalling the stored mark.

2. The method of claim 1, wherein the defining comprises defining the mark automatically in response to the accessing.

3. The method of claim 1, wherein the defining comprises defining the mark automatically in response to the accessing lasting at least a threshold duration of time.

4. The method of claim 1, wherein the system metadata comprises at least one of:
a time associated with the accessing;
information identifying a former resource from which the accessed resource was accessed;
information identifying a later resource accessed from the accessed resource;
a location of the computer during the accessing;
a characteristic of the environment of the computer during the accessing; and
a subliminal cue applied to the content of the resource during the accessing.

5. The method of claim 4, wherein the recalling comprises recalling the stored mark in response to a mark search request that comprises information indicative of the system metadata of the defined mark.

6. The method of claim 1, wherein the mark data further comprises user annotation data associated with a user's reaction to the accessed resource.

7. The method of claim 6, wherein the recalling comprises recalling the stored mark in response to a mark search request that comprises information indicative of the user annotation data of the defined mark.

8. The method of claim 1, wherein the resource comprises a photograph captured by a camera of the computer.

9. A method for operating a computer comprising:
accessing, by the computer, a resource;
defining a mark for the accessed resource, wherein the defined mark comprises:
resource content retrieval data that is operative to provide at least a portion of the content of the accessed resource; and
system metadata associated with the accessing;
generating a question based on the defined mark; and
presenting the question to a user of the computer.

10. A method for operating a computer comprising:
accessing, by the computer, a resource;
in response to the accessing, automatically detecting that the accessed resource comprises audio content with a tone range less than a threshold;
in response to the detecting, automatically extending the tone range of the audio content; and
automatically playing back, by the computer, the audio content with the extended tone range.
